(19) United States
(12) Patent Application Publication
(10) Pub. No.: US 2026/0278850 A1
(43) Pub. Date: Sep. 17, 2026

(54) THREE-DIMENSIONAL GAUSSIAN SPLAT COMPRESSION

(71) Applicant: Apple Inc., Cupertino, CA (US)

(72) Inventors: Alican Nalci, Cupertino, CA (US); Kedar Shriram Tatwawadi, Santa Clara, CA (US); Vijayaraghavan Thirumalai, San Diego, CA (US); Zhiqi Chen, Santa Clara, CA (US); Dzung T. Hoang, Morgan Hill, CA (US); Xiaohua Yang, San Jose, CA (US); Van Luong Pham, San Diego, CA (US); Oren Rippel, Vancouver (CA); Linfeng Guo, Cupertino, CA (US); Brandon Allan Morningred, Boulder, CO (US); David K. Wong, San Mateo, CA (US); Dazhong Zhang, Saratoga, CA (US); Hayden James Barsotti, Mountain View, CA (US); Jie Hu, Fremont, CA (US); Jinbo Qiu, San Jose, CA (US); Jingteng Xue, Los Altos, CA (US); Khaled Mammou, Danville, CA (US); Xingyu Zhang, Mountain View, CA (US)

(21) Appl. No.: 19/546,937

(22) Filed: Feb. 23, 2026

Related U.S. Application Data
(60) Provisional application No. 63/771,162, filed on Mar. 13, 2025.

(51) Int. Cl. G06T 9/00; G06V 40/16

(52) U.S. Cl. CPC G06T 9/002; G06V 40/176

(57) ABSTRACT

Various implementations disclosed herein include devices, systems, and methods that compress three-dimensional Gaussian splat (3DGS) data based on a compression scheme. For example, a process may include obtaining 3DGS data representing at least a portion of an element and includes multiple two-dimensional (2D) textures that each represent values for a respective parameter at different 2D positions within the respective 2D texture. The process may further include generating a compressed version of the 3DGS data that represents the at least the portion of the element based on a compression scheme, the compressed version of the 3DGS data including a reduction of the multiple 2D textures of the 3DGS data. The process may further include providing the compressed version of the 3DGS data, where a three-dimensional (3D) view of a representation of the at least the portion of the element is presented based on the compressed version of the 3DGS data.

### CROSS-REFERENCE TO RELATED APPLICATIONS

This application claims the benefit of U.S. Provisional Application Ser. No. 63/771,162 filed Mar. 13, 2025, which is incorporated herein in its entirety.

### TECHNICAL FIELD

The present disclosure generally relates to electronic devices, and in particular, to systems, methods, and devices for encoding and decoding of latent information that corresponds to three-dimensional (3D) information.

### BACKGROUND

Existing techniques for compressing image and video data for transmission and storage may not accurately or efficiently be used for compressing 3D data associated with honestly presenting current (e.g., real-time) representations of the appearances of objects. Some techniques have emerged for real-time radiance field rendering, offering improved performance in terms of both quality and speed. However, these 3D models may be limited by storage and/or memory demands. Thus, it may be desirable to provide a means of efficiently compressing 3D data in order to provide more accurate, honest, and/or current representations of objects, such as users (e.g., personas).

### SUMMARY

Various implementations disclosed herein include devices, systems, and methods that compress three-dimensional Gaussian splatting (3DGS) data. Gaussian splatting is a technique where individual three-dimensional (3D) points are represented as Gaussian distributions (like “splats”) with shape and color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In some implementations, the 3DGS data can use two-dimensional (2D) textures or maps (e.g., values in 2D pixel maps) to represent 3DGS parameters. The 3DGS data includes multiple 2D textures that each represent values for a respective parameter at different 2D positions within the respective 2D texture such that each 2D texture's pixel values (e.g., at particular locations within the texture) correspond to the respective parameter's values for corresponding portions of an element that is represented (e.g., a persona, an object, an environment, and the like). The 3DGS parameters may be categorized by a splat parameter type (e.g., location (L), rotation (R), scale(S), and color (C)), and the compression may involve parameter type-specific compressions, e.g., compressing multiple 2D textures corresponding to the same parameter type together into a fewer number of 2D textures. The 3DGS compression techniques described herein may be used for any 3D object/environment.

In some implementations, the compressed 3DGS data may be transmitted (e.g., for use displaying the 3D object/environment on another device during a live communication session) and the amount of compression (e.g., a quantization parameter (QP) allocation scheme) may be configured (smaller or greater) based on a context. For example, the compression may be configured to facilitate bitrate allocations corresponding to different network bandwidth conditions, e.g., using more bandwidth when available or needed based on the context. The context may be associated with the rendering (e.g., quality constraints), the communication session parameters, and the like. In some embodiments, smaller QP values (e.g., less compression) may be applied to particular regions (e.g., mouth/eye regions). In some embodiments, machine learning (e.g., neural networks) may be used for any of the linear networks described herein.

In an exemplary implementation, a first set of captured user data (e.g., enrollment data) may be used to generate user representation data including 3DGS data (e.g., a multi-channel Gaussian UV map) at a first device (e.g., a sending device), compressed at the first device using a compression scheme (e.g., a QP allocation scheme), and sent to a second device (e.g., a viewing device). The user representation data may be provided as compressed 3DGS data to a viewing device to render a view of the representation (e.g., rendering a live view of a sender's persona) by decompressing the compressed 3DGS data and generating splats corresponding to modified user representation data. A persona is a representation of a user, like an avatar. Advantageously, splatting avoids the need to use a mesh to avoid the appearance of holes and provides other advantages. The 3D representations of the user at multiple instants in time may be generated on a viewing device that decompresses and combines the 3DGS data and uses the combined data to render views, for example, during a live communication (e.g., a virtual communication or a co-presence) session.

In some implementations, data associated with each splat of a user representation may represent a texture/color, a 3D position, direction and angle information (e.g., cone of visibility), a splat shape, a level of transparency, a covariance (e.g., how a splat is stretched/scaled), and the like. The splats may be a 3D Gaussian distribution in a two-dimensional (2D) space with color/density (e.g., parameterization), where a person's face may be utilized as a grid, and a number of splats may be determined based on a ray off the face/grid. The grid/parameterization of the splat distribution provides higher quality data, may be faster to train a machine learning model, and may provide faster (e.g., real-time) rasterization. In some implementations, 3D mapping information (e.g., identifying x,y,z positions corresponding to UV coordinates of a UV map) may be generated at enrollment (e.g., Gaussian UV maps).

In general, one innovative aspect of the subject matter described in this specification can be embodied in methods that include the actions of, at a processor of a device, obtaining three-dimensional Gaussian Splat (3DGS) data representing at least a portion of an element, wherein the 3DGS data includes multiple two-dimensional (2D) textures that each represent values for a respective parameter at different 2D positions within the respective 2D texture such that pixel values of each 2D texture correspond to values of the respective parameter for corresponding portions of the element that is represented. The actions may further include generating a compressed version of the 3DGS data that represents the at least the portion of the element based on a compression scheme, wherein the compressed version of the 3DGS data includes a reduction of the multiple 2D textures of the 3DGS data. The actions may further include providing the compressed version of the 3DGS data, wherein a three-dimensional (3D) view of a representation of the at least the portion of the element is presented based on the compressed version of the 3DGS data.

These and other embodiments can each optionally include one or more of the following features.

In some aspects, each of the 3D splats are associated with a particular splat parameter type of a plurality of splat parameter types. In some aspects, generating the compressed version of the 3DGS data based on the compression scheme includes selecting one or more the plurality of splat parameter types, and applying the compression scheme using the selected one or more the plurality of splat parameter types. In some aspects, the plurality of splat parameter types includes at least one of a location, a rotation, a scale, a color, and an opacity.

In some aspects, the compression scheme is determined based on a network bandwidth condition. In some aspects, the compression scheme is determined based on a context associated with providing the compressed version of the 3DGS data. In some aspects, the compressed version of the 3DGS data includes a reduction in at least of a number, a size, and an amount of data associated with the multiple 2D textures of the 3DGS data. In some aspects, the compression scheme includes a machine learned method, a neural network, or a compression mapping algorithm. In some aspects, the compression scheme includes a dimensionality-reduction transform. In some aspects, the dimensionality-reduction transform includes a Karhunen-Loeve (KL) transform.

In some aspects, the actions further include providing the compressed version of the 3DGS data to a different device to generate the view of the representation of the at least the portion of the element, wherein the different device decompresses the compressed version of the 3DGS data based on the compression scheme.

In some aspects, generating the compressed version of the 3DGS data that represents the at least the portion of the element is based on identifying particular regions of the element, wherein the compressed version of the 3DGS data includes the reduction of the multiple 2D textures of the 3DGS data associated with the identified particular regions of the element at a rate that is different than other regions of the element.

In some aspects, the 3D view of the representation of the at least the portion of the element is presented for multiple frames corresponding to successive instants in time and is used to provide a time-varying view of the element.

In some aspects, providing the view includes rendering a subset of splats based on the splat parameter data. In some aspects, the at least the portion of the element includes a face portion and an additional portion of a user. In some aspects, the 3D view of the representation of the at least the portion of the element is presented based on 3D point cloud points associated with distribution data defining sizes and shapes for rendering the 3D point cloud points as splats.

In some aspects, the 3DGS data includes 3D Gaussian parameters. In some aspects, the 3D Gaussian parameters include at least one of position information, color information, covariance information, transparency information, an orientation, opacity information, extent information in each axis, rotation data, a scale, and semantic information.

In some aspects, the device is a sender's device, wherein the compression scheme is selected based on data obtained during a communication session with a viewer's device associated with the view of the representation of the at least the portion of the element.

In some aspects, the 3DGS data representing the at least the portion of the element is generated and updated during an enrollment process based on images of a face of a user captured while the user is expressing a plurality of different facial expressions. In some aspects, the 3DGS data representing the at least the portion of the element is generated via a machine learning model trained using training data obtained via one or more sensors in one or more environments. In some aspects, providing the 3D view of the representation of the at least the portion of the element includes displaying the representation in an extended reality (XR) environment. In some aspects, the 3DGS data is obtained in a first physical environment, and the 3D view of the representation of the at least the portion of the element is displayed in a view of a second physical environment that is different than the first physical environment.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device obtaining sensor data from a user according to some implementations.

FIGS. 2A-2D illustrate examples of three-dimensional Gaussian splats (3DGS) for use with generating views of three-dimensional (3D) representations in accordance with some implementations.

FIG. 3 illustrates an example of generating and displaying a stereo view of splats on a device in accordance with some implementations.

FIG. 4 illustrates an example of encoding 3DGS data based on a compression scheme in accordance with some implementations.

FIGS. 5 and 6 illustrate examples of compressing a two-dimensional (2D) texture representation of a 3DGS scene in accordance with some implementations.

FIG. 7 illustrates exemplary electronic devices operating in different physical environments during a communication session of a first user at a first device and a second user at a second device with a view of a combined three-dimensional (3D) representation of the second user for the first device in accordance with some implementations.

FIG. 8 illustrates an example of generating a representation of a user by rendering splat parameter data using a 3DGS compression scheme in accordance with some implementations.

FIG. 9 is a flowchart representation of a method for providing a compressed version of 3DGS data using a compression scheme in accordance with some implementations.

FIG. 10 is a block diagram illustrating device components of an exemplary device according to some implementations.

FIG. 11 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

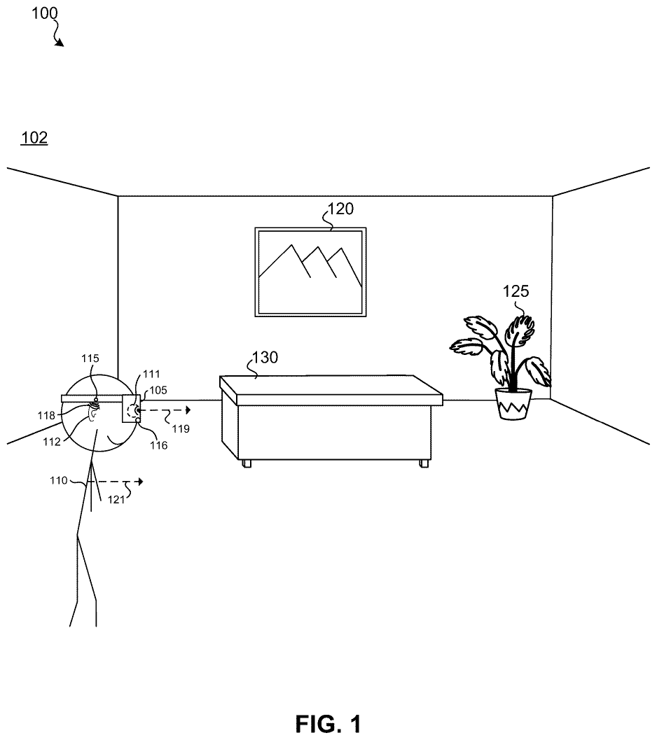

FIG. 1 illustrates an example environment 100 of exemplary electronic device 105, operating in a physical environment 102. In some implementations, electronic device 105 may be able to share information with another device or with an intermediary device, such as an information system. Additionally, physical environment 102 includes user 110 wearing device 105. In some implementations, the device 105 is configured to present views of an extended reality (XR) environment, which may be based on the physical environment 102, and/or include added content such as virtual elements.

In the example of FIG. 1, the physical environment 102 is a room that includes physical objects such as wall hanging 120, plant 125, and desk 130. The electronic device 105 may include one or more cameras, microphones, depth sensors, motion sensors, or other sensors that can be used to capture information about and evaluate the physical environment 102 and the objects within it, as well as information about user 110.

In the example of FIG. 1, the device 105 includes one or more sensors 116 that capture light-intensity images, depth sensor images, audio data or other information about the user 110 (e.g., internally facing sensors and externally facing cameras). For example, the one or more sensors 116 may capture images of the user's (e.g., user 110) forehead, eyebrows, eyes, eye lids, cheeks, nose, lips, chin, face, head, hands, wrists, arms, shoulders, torso, legs, or other body portion. For example, internally facing sensors may see what's inside of the device 105 (e.g., the user's eyes and around the eye area), and other external cameras may capture the user's face outside of the device 105 (e.g., egocentric cameras that point toward the user 110 outside of the device 105). Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

In some implementations, the device 105 includes an eye tracking system for detecting eye position and eye movements via eye gaze characteristic data. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 110. Moreover, the illumination source of the device 105 may emit NIR light to illuminate the eyes of the user 110 and the NIR camera may capture images of the eyes of the user 110. In some implementations, images captured by the eye tracking system may be analyzed to detect position and movements of the eyes of the user 110, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 105.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data).

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding or a scene understanding based on sensor data obtained by a user worn device, such as first device 105. Such a user understanding may be indicative of a user state that is associated with providing user assistance or facilitating a communication session. In some example, a user's appearance or behavior or an understanding of the environment (scene understanding) may be used to recognize a need or desire for assistance so that such assistance can be made available to the user. For example, based on determining such a scene understanding, augmentations may be provided to assist the user by enhancing or supplementing the user's abilities, e.g., information about an environment to a person. Additionally, a user understanding and/or a scene understanding may be utilized to customize a viewing experience, e.g., selecting a rendering mode, which will be further discussed herein.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

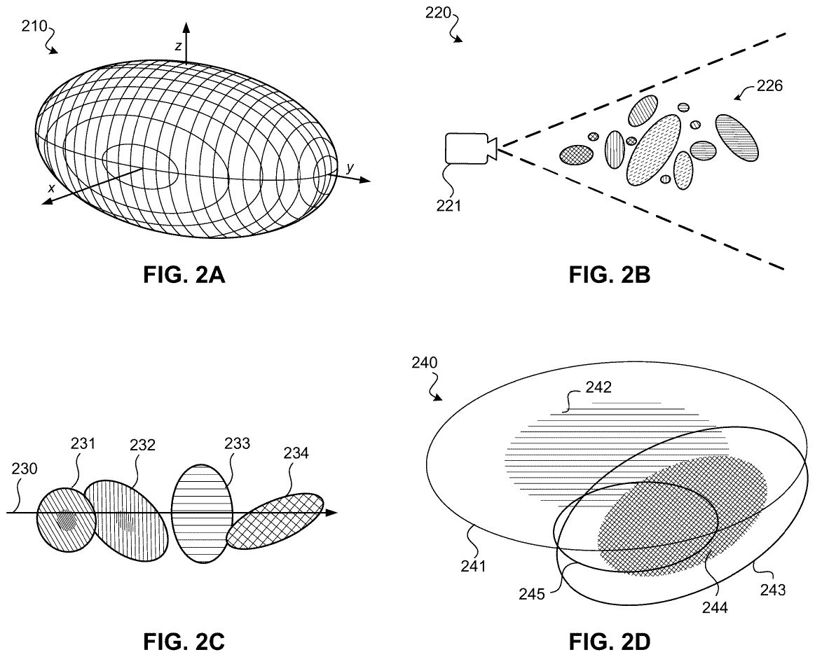

FIGS. 2A-2D illustrate examples of 3D Gaussian splats for use with generating views of 3D representations in accordance with some implementations. For example, 3D Gaussian Splatting (3DGS) may be used for 3D modeling to represent complex scenes as a combination of a large number of colored 3D Gaussians which are rendered into camera views via splatting-based rasterization. The positions, sizes, rotations, colors and opacities of these Gaussian splats can then be adjusted via differentiable rendering and gradient-based optimization such that they represent the 3D scene given by a set of input images.

FIG. 2A illustrates a 3D Gaussian splat 210, e.g., an ellipsoid shape formed by a 3D gaussian distribution. The 3D Gaussian splat 210 may be used to represent a position (μ), such as xyz coordinates. The 3D Gaussian splat 210 may be used to represent direction and angle information for a cone of visibility. The 3D Gaussian splat 210 may further represent rotation and scale (e.g., Σ: covariance matrix), opacity (α), color (e.g., RGB values), anisotropic covariance, and spherical harmonic (SH) coefficients. FIG. 2B illustrates an environment 220 for rendering splats 226 based on a visibility direction of a camera 221. FIG. 2C illustrates ordering the splats along a camera look-at direction along a ray 230. For example, the splats 231, 232, 233, 234 are identified and ordered along the ray 230. For example, Gaussian splatting is a technique where individual 3D points are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints. FIG. 2D illustrates an environment 240 for blending splats 241, 242, 243, 244, 245 that may be viewed along the ray 230 direction from the camera view by composing the splats 231, 232, 233, 234 on an image plane. Some implementations may use screen-to-splats (e.g., similar to ray-casting techniques), splats-to-screen (e.g., similar to projection techniques), a combination thereof, or other techniques for composing splats.

3DGS is a volume rendering technique for 3D data without converting the data into primitives such as lines or surfaces. 3DGS uses a collection of 3D Gaussians, similar to point clouds in 3D, although each Gaussian is anisotropic with covariance matrix that's not necessarily diagonal. A single 3D gaussian splat is then defined according to the

$${f}_{i} ( p ) = σ ( {α}_{i} ) exp [ - \frac{1}{2} ( p - {u}_{i} ) {\sum }_{i}^{- 1} ( p - {μ}_{i} ) ]$$

where, σ(αᵢ) represents the opacity of each Gaussian i, with ranging from 0 invisible to transparent to fully opaque 1 (1 variable). The location of each Gaussian is represented by μᵢ=(x, y, z) which has 3 variables to represent the relative location in x, y, z coordinates, and Σᵢ=RS(RS)^{T} representing the shape parameters, usually with a rotation component R (4 variables) and scale component S (3 variables). Parameters may be stored per Gaussian to represent shape, visibility, and location features. Each splat may be further characterized by spherical color harmonics (SH) to provide a view-dependent color representation using Laplace equations along the surface of a sphere:

$${Y}_{k}^{p} ( θ , ϕ ) = \frac{{( - 1 )}^{k}}{{2}^{k} k !} \sqrt{\frac{( 2 k + 1 ) ( k + p ) !}{4 π ( k - p )}} exp [ ip ϕ ] {sin ( θ )}^{- p} \frac{{d}^{k - p}}{d {cos ( θ )}^{k - p}} {sin ( θ )}^{2 k}$$

where given the view angles θ and φ, the function can be defined as a function of orders k and p to define different spherical functions. These can be weighted and summed to obtain an average representation of color at different view angles. For instance, for k=p=0, the function would represent the same color everywhere on the sphere (e.g. DC term for color channel). A degree of 1 in SH definition means, p could each range from [-1, 0, 1] and k can range [0, 1] creating 4 distinct functions per color channel, in the RGB space with 3 color channels, this would mean 12 different SH components are needed. In some implementations, a possible configuration needs 23 parameters to represent all properties of a single component of a 3DGS scene. For example, a typical 3DGS scene can involve thousands of Gaussian splats which requires a high cost to store 3DGS data, and also a higher cost for transmission of 3DGS-based data for transmission over networks for communications.

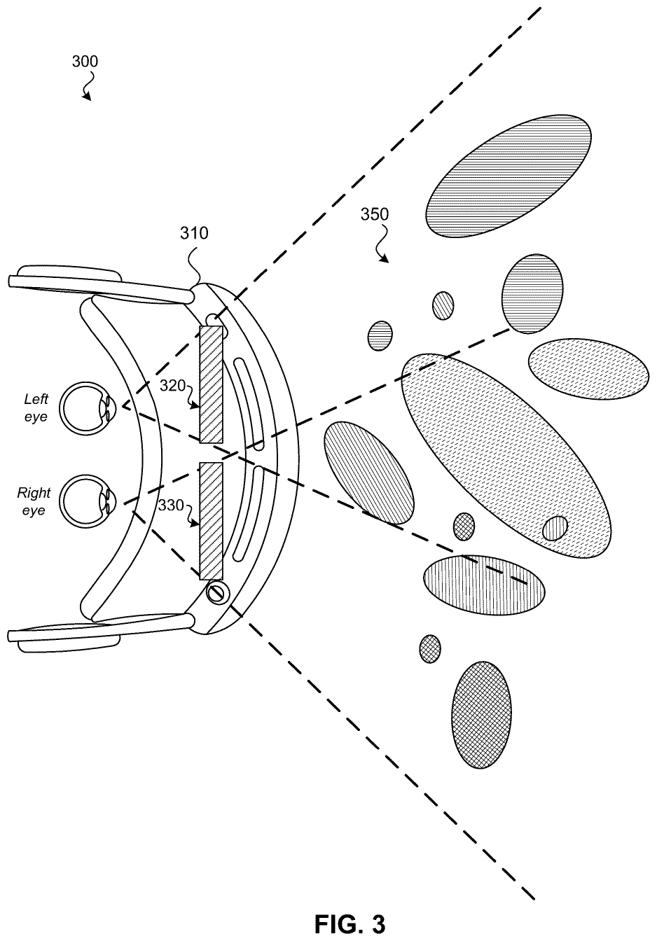

FIG. 3 illustrates an example environment 300 for generating and displaying a stereo view of splats on a device (e.g., an HMD) in accordance with some implementations. For example, the device 310 is an HMD that includes a first display 320 for a left eye view and a second display 330 for a right eye view. The first display 320 and the second display 330 may then view the rendered splats 350 for each respective viewpoint accordingly. In some implementations, the generated images for each viewpoint may be rendered as a single mono image (e.g., render for one eye), or the images may be presented as a stereo view, as illustrated in FIG. 3. Additionally, or alternatively, in some implementations, the generated images for each viewpoint may be rendered as a single grid mesh, or a combination of stereo grid meshes.

In some implementations, culling techniques for selecting a subset of the splat data for rendering a stereo view may be applied in a similar technique described herein for each eye separately, or may be applied as culling for the overall viewer's FoV, gaze, and/or occlusions based on the viewpoint. For example, a particular splat for a left eye viewpoint may be occluded, and thus not selected to be rendered, but that same splat for a right eye viewpoint may need to be rendered to avoid any holes/gaps from the rendering for the right eye viewpoint. Alternatively, in some implementations, if only one right eye or left eye viewpoint requires that a particular splat needs to be rendered, then the system described herein will render that splat for both viewpoints to avoid any mismatches or voids for the overall stereo view of the viewer.

In some implementations, varying a rendering approach for different resolutions based on a context of a viewing experience, culling of splats, and other techniques may be used to improve rendering efficiency. As further described herein, a splat rendering approach may be selected based on one or more criterion associated with determining a context of a viewing experience and continuously updating that rendering approach (e.g., varying variance, color, size, etc. of splats using 3D Gaussian splatting rendering techniques) as the viewing experience may change.

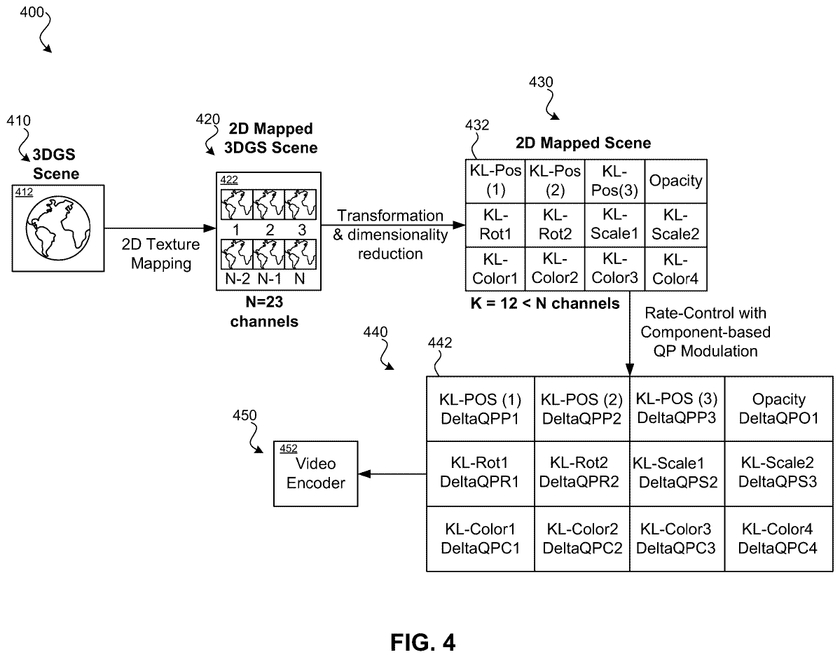

FIG. 4 illustrates an example of encoding 3DGS data based on a compression scheme in accordance with some implementations. In particular, FIG. 4 illustrates an example compression process 400 (e.g., a compression scheme) for encoding 3DGS data based on a Karhunén-Loeve (KL)-transform with dimensionality reduction and rate-control with quantization parameter (QP) modulation based on 3DGS components for a video encoder.

In some implementations, rate-control algorithms may be used with standard video codecs to provide best video quality given bitrate constraints or other context data, such as a context associated with a rendering (e.g., quality constraints). Bitrate constraints may be determined by the network bandwidth conditions for streaming, transcoding and digital communications or may also be based on requirements for offline storage. Traditionally rate control is achieved by dynamically adjusting the encoding parameters of a video codec given a source video where the number of bits spent per-frame is controlled by choosing a suitable structure for groups of frames, types of each frame, a set of tools for encoding each frame and also adjusting the QP per frame spatially or across frames temporally based on statistics. There are many ways to ensure efficient rate control including in-loop approaches based on normative QP modulation at different granular levels as well as out-of-loop approaches that incorporate frame super-resolution. QP modulation is most widely used to provide a good rate distortion trade-off maximizing the video quality at an acceptable rate target that can track the target bitrates.

In some implementations, KL transforms may include data-driven transforms which are derived based on the statistics of the underlying data. These KL transforms may be used to achieve dimensionality reduction (i.e. compression) or to re-organize data using a set of eigenbases that best represent the data. More formally, given a source data vector X that is zero mean, a covariance matrix φ_{N}=E[XX^{T}] can be derived such that each element of the covariance matrix

$${[ {Φ}_{N} ]}_{i , j} = E [ {X}_{i} {X}_{j}^{T} ] = {R}_{X} ( \vert i - j \vert )$$

is defined by the autocorrelation function R_{X}(k). There exists a set of N orthonormal eigenvectors e₁, e₂, . . . , e_{N} and a corresponding set of N non-negative eigenvalues λ₁, λ₂ . . . , λ_{N} for Φ_{N} such that Φ_{N}eⱼ=λⱼeⱼ. The eigenvectors are orthogonal to each other and form a new basis under which the data can be represented by a transformation y=V^{T}x where V=V^{T} is a unitary transformation matrix (or the KL transform matrix) of the source vector x containing the eigenvectors e₁, e₂, . . . , e_{N}. One way to derive such a transform via Singular Value Decomposition (SVD) which can decompose the original data as x=USV^{T} where V is a full-rank matrix that defines the right singular vectors or eigenvectors. By omitting the least important basis vectors that correspond to smallest eigenvalues one can obtain a low-rank representation of the data by X̅=XV̅ where V̅ is the matrix of eigenvectors after dropping eigenvectors that correspond to smaller eigenvalues. In some implementations, different mappings (e.g., other than KL-transforms) that can reduce the number of channels of the original data may be implemented by using multiple linear or non-linear layers than can constitute a neural network. Such layers or networks may be trained to reduce the dimensions of the data with distortion metrics other than the mean squared error.

In an exemplary implementation, the compression process 400 may obtain 3DGS scene data 412 from a 3DGS scene process 410 (e.g., 3DGS data associated with an object, scene, or a person is obtained). The compression process 400 may then apply 2D texture mapping to the 3DGS scene data 412 during 2D mapped 3DGS scene process 420 to generate 2D mapped data 422 that includes 23 parameters to represent all properties of a single component of a 3DGS scene (e.g., N=23 channels). 2D representations of 3DGS data may be obtained using a 2D texture mapping process 420. For example, parameters of each splat can be mapped into a 2D map for each 3DGS channel (e.g., 23 channels) separately or several 3DGS channels may be combined and mapped to a smaller subset of 2D maps. These maps can be regularized to contain certain structure (e.g., by smoothing) or could aim to preserve the details in such a way that upon doing an inverse 2D to 3D mapping the original scene may be reconstructed with minimal error. Embodiments of the present disclosure may use a 3D to 2D mapping process to map the channels or parameters of a 3DGS scene into a 2D representation which is suitable for encoding with a traditional video codec such as High-Efficiency Video Coding (HEVC), Versatile Video Coding (VVC), AOMedia Video 1 (AV1), and AOMedia Video 1 (AV2) which rely on encoding 2D image/video data. For example, the 3DGS scene 412 may be mapped into 2D representations (or channels containing 2D representations of the channels) as 2D mapped 3DGS scene data (e.g., 2D mapped data 422). For instance, assuming that only the 3D gaussians of a scene along the surface of the 3DGS scene are considered, then location parameters (x, y, z) of the 3DGS scene can be mapped to different channels (e.g., Channel 1, Channel 2, Channel 3, Channel N−2, Channel N−1, Channel N, etc.). For example, the 2D mapped scene process 430 determines different KL transforms and dimensionality reductions of the 2D mapped data 422 in order to reduce the number of 2D patches, as illustrated by the 2D mapped scene data 432.

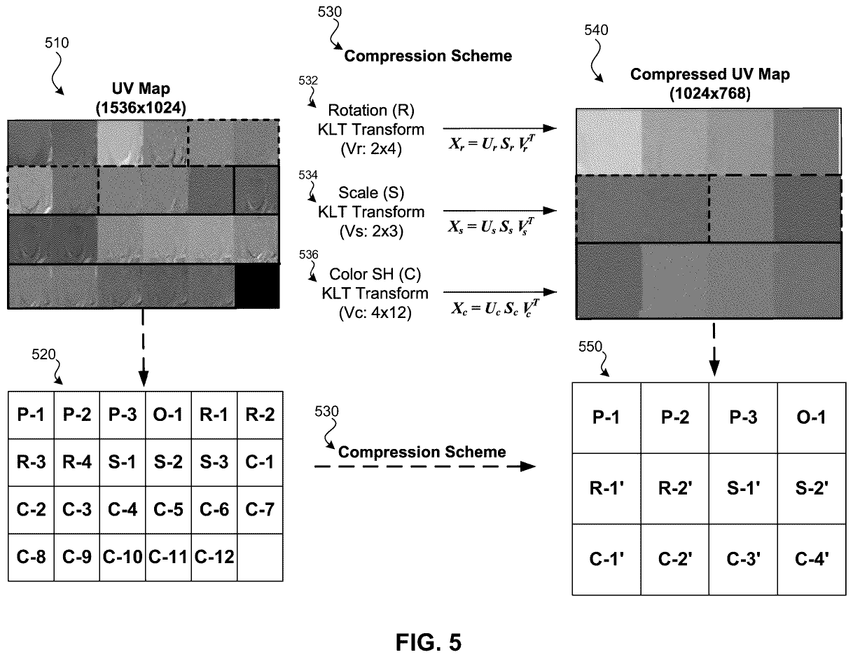

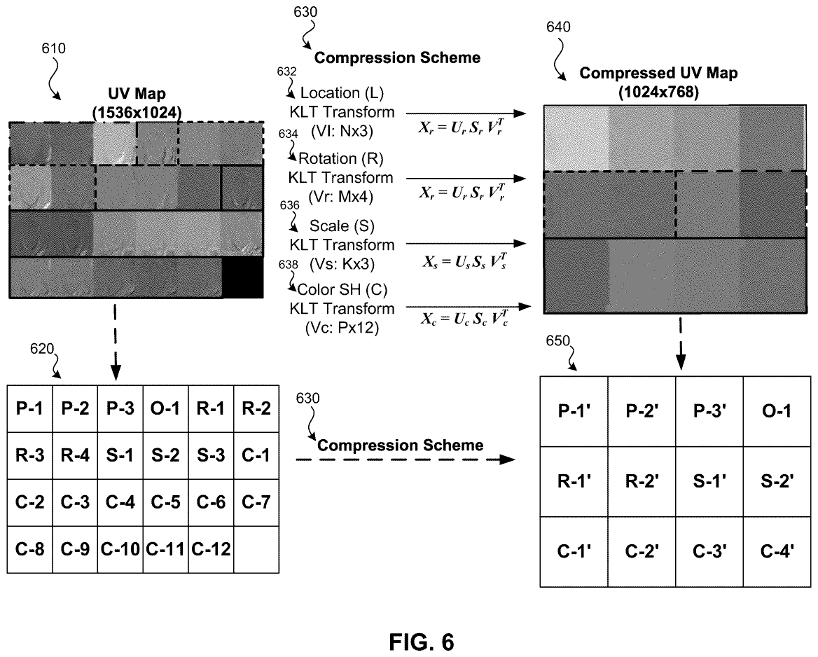

In some embodiments, if a 3DGS scene consists of M number of Gaussian Splats each with N channels, each channel may be mapped into a 2D representation (e.g., smaller 2D patches) that captures the M Gaussians in 2D for that channel. In one example, each 2D patch corresponding to a single channel may be 256x256 pixels, and if there are N channels, and with each channel represented as a 256x256 patch, the smaller patches may be reordered and “stitched” to form a larger atlas or a frame. For example, an atlas that consists of 6 columns and 4 rows may contain 24 patches of 256x256 resulting in a single image of 1536x1024 pixels as a 3DGS atlas. For example, each smaller 256x256 2D patch in the 2D mapped data 422 may correspond to a separate 3DGS channel such as location, rotation, scale, opacity, color, etc. (e.g., 3DGS parameters), and such 2D patches may be compressed with a standard image or video codec such as VVC (H.266), HEVC (H.265), and the like. In some implementations, the 2D patches may undergo some processing where they may also be stitched or combined together in some form and this information may be compressed with a standard codec. Some examples of such processing are shown in FIGS. 5 and 6 where the patches are combined or “stitched” together to form a larger 2D texture.

In some implementations, the 2D mapped scene data 432 may be applied to a rate control and QP modulation process 440. The rate control and QP modulation data 442 illustrates a representative atlas that contains different 3DGS channels with KL transformation (e.g., after applying the KL-transform and dropping some KL-channels, the remaining KL-mapped channels: KL-Pos (1), KL-Pos (2), . . . , KL-Color (4) are obtained). This 2D KL-mapped low-rank data may be compressed then using a traditional video codec, or the like. For example, a video encoder 452 during the video compression process 450 may compress the frames over time traditionally with the allocated QP values per component.

In some implementations, the rate control and QP modulation data 442 given that the location of each KL-mapped channel may be spatially fixed (e.g., KL-Pos (1) is located on the top-left or KL-component patch “i” is located starting from location {Xᵢ, Yᵢ}), then a different quantization parameter (QP) may be allocated for each KL-mapped channel. In other words, a larger QP value reduces the bitrate required to transmit the information on the specific channel although it also causes a larger distortion for the corresponding channel. In some embodiments, if the channel corresponds to a smaller eigenvalue, then on the final reconstruction the incurred distortion will be limited as compared to a channel that corresponds to a larger eigenvalue.

In some embodiments, the delta QP values, as illustrated in the rate control and QP modulation data 442, may be selected such that for position related KL patches: KL-Pos (1) has a negative smaller QP value and the channel is quantized less aggressively, KL-Pos (2) may have a 0 deltaQP value and KL-Pos (3) can have a positive delta QP value meaning it is quantized more aggressively compared to the previous position channels. In some embodiments, the selection of the delta QP values may be based on spatial variations of the QP value compared to the base QP of the frame. Additionally, or alternatively, in some embodiments, different delta QP values (DeltaQPP1, DeltaQPP2, . . . DeltaQPC4) may be selected according to the eigenvalues corresponding to each channel after a KL transform (or a Principal Component Analysis (PCA)-like transform). In other words, a smaller quantization parameter may be given to channels with larger eigenvalues quantizing important channels less aggressively, and a larger quantization parameter given to channels with smaller eigenvalues of the same SVD decomposition to quantize those less important channels more relatively. In some embodiments, QP modulation may be utilized with a finer granularity for each channel after a KL transform. For example, DeltaQPP1, DeltaQPP2, . . . . DeltaQPC4, etc., for each KL-component, may be separately corresponding to different 3DGS channels. Moreover, each KL-component may be spatially divided and the QP value may be altered per region (e.g., regions that may are more important or may move during rendering-a mouth region during a communication session). For example, each patch may be divided into coding blocks with smallest squares, and particular squares may be applied a smaller QP value and quantized less aggressively since these finer regions may contain important information.

In some implementations, the compression process 400 encapsulates a rate-control and compression scheme for 3DGS data. For example, a 3DGS scene (e.g., 3DGS scene data 412) may be converted into 2D patches by mapping (e.g., 2D mapped data 422). Multiple patches (N) may be obtained to correspond to different parameters of the 3D model with 2D texture mapping. This forms a larger “atlas” or a frame that contains a 2D representation of the 3D model. Then a dimensionality reduction approach may be applied such as KL-transforms (KLTs) (or other generic transforms) to reduce the pixel dimensions of the larger atlas into a “low-rank” atlas, where each patch here may have a smaller number of channels (K<N) (e.g., 2D mapped scene data 432). The 2D mapped scene process 430 reduces the pixel dimensions and hence reduces the bitrate required to send the texture information. Furthermore, a different QP value may be applied to each channel/component after the KL-transform or generic transform, such that smaller quantization is applied to more important channels and a larger quantization may be applied to less important channels. A measure of importance of a channel may be derived based on the eigenvalues (or a fraction of the eigenvalue per component across all components) of the KL-transformed channels of 3DGS textures (e.g., rate control and QP modulation data 442). In some implementations, a video encoder 452 during the video compression process 450 may compress the frames over time traditionally with the allocated QP values per component.

In some embodiments, a 2D texture mapping may be obtained for each component of the original 3DGS representation. In some implementations, this may be accomplished by training a neural network to warp the 3DGS across a surface into a 2D map. For example, there may be a separate patch for each 3DGS component (e.g., location, rotation, scale, opacity, color, etc.). In some embodiments, a 2D texture mapping may be obtained to output N distinct patches to represent the 3DGS scene with each patch not necessarily representing a separate 3DGS component but a collection of different components. In some embodiments, a 2D texture mapping method may apply to only certain 3DGS components. For instance, 2D maps may be obtained for color, rotation, scale, and opacity but not for the location components which may apply a different compression method such as vector quantization or lossless coding, as further illustrated in FIG. 5 (without location compression) and FIG. 6 (with location compression).

In some embodiments, a KL transform over the 3DGS parameters (after 2D mapping) may be replaced with a learned transform. The learned transform may be a simple linear layer and also non-linear neural network layers that may be trained to achieve the dimensionality reduction goal such that N=23 channels can be reduced to K=12 channels with a learned transformation instead. In some embodiments, a QP value may be applied per KL component or tile/patch that is derived after a transform similar to and such QP value may be determined by computing the importance of that KL component or tile/patch. In some embodiments, a smaller QP value may be given to a KL component (after a KL-transform) if the eigenvalue associated with that KL component is larger than the other KL components. In some embodiments, a larger QP value may be assigned to a KL component if the eigenvalue associated with that KL component is smaller than compared to the eigenvalues of other KL components. In some embodiments, QP value may be assigned per KL component based on the desired bitrate such that for higher bitrate targets smaller QP values may be used as an offset across all KL components.

In some embodiments, some KL components may be quantized less aggressively by default compared to other KL components (e.g., different 3DGS components, such as, inter alia, color, opacity, scale, etc.). For instance, KL components that correspond to scale/rotation may be quantized more (larger QP values) compared to KL components that correspond to location and color. In some embodiments, decision to assign QP values per KL components may be decided by a reinforcement learning scheme, where a machine learning (ML) model may be trained to assign different QP values to each patch to maximize the final reconstructed 3DGS scene after decompression and inverse mapping from 2D to 3D. In some embodiments, a QP map may be obtained for smaller blocks and each QP value that corresponds to each square may be derived by an ML or reinforcement learning algorithm. For example, a criteria to assign a QP value per block may intend to maximize the reconstruction quality of the 3DGS scene after decompression and inverse mapping from 2D to 3D for a given bitrate target.

In some embodiments, a KL-transform may be applied in the temporal domain, e.g., to reduce the number of encoded frames. In some embodiments, a KL-transform may be applied to reshape a group of X frames into a group of Y frames where X and Y are integer numbers and Y<X. Assume that the single vector R_{(t,i)-65,535} represent the data of channel t^{th} of the frame t the group of X frames, a single vector R_{(i)-65,535xX} will represent the data of the channel cross all the frame in this group. We may apply a linear transform V̅ᵣ to patches R_{(i)-65,535xX} such that R^{⊥~}=RV̅ᵣ, where V̅ᵣ is a X×Y matrix and the low-rank rotation data R is obtained with dimensions 65,535xY. By doing such the transform, X input frames are represented by Y frames. In the decoder side, the group of Y reconstructed frames may be inversely transformed to derive X reconstructed frames.

FIG. 5 and FIG. 6 illustrate examples of compressing a two-dimensional (2D) texture representation of a 3DGS scene in accordance with some implementations. FIGS. 5 and 6 illustrate 2D texture mapping to represent a 3DGS scene with each patch not necessarily representing a separate 3DGS component but a collection of different components (e.g., a UV map of 24 channels (1536x1024)) that may be compressed (e.g., a UV map of 12 channels (1024x768)). For example, FIG. 5 illustrates 2D maps that may be obtained for color, rotation, scale, and opacity, but not for the location components which may apply a different compression method such as vector quantization or lossless coding. However, FIG. 6 illustrates 2D maps that compresses color, rotation, scale, and location.

FIG. 5 illustrates compressing a UV map 510 to a compressed UV map 540 via a compression scheme 530 for rotation (R) 532, scale(S) 534, and color (C) 536. FIG. 5 further illustrates the UV map table 520 corresponding to the UV map 510 and the compressed UV map table 550 corresponding to the compressed UV map 540. The 24 channels of 2D texture data illustrated by the UV map 510 are delineated by the UV map table 520 for different 3DGS components, such as location (P) (e.g., position coordinates x, y, z), opacity (O), rotation (R), scale(S), and color (C). The 12 channels of compressed 2D texture data illustrated by the compressed UV map 540 are delineated by the compressed UV map table 550 for different compressed 3DGS components (if applicable), such as compressed rotation (R′), compressed scale (S′), and compressed color (C′).

FIG. 6 illustrates compressing a UV map 610 to a compressed UV map 640 via a compression scheme 630 for location (L) 632, rotation (R) 634, scale(S) 636, and color (C) 638. FIG. 6 further illustrates the UV map table 620 corresponding to the UV map 610 and the compressed UV map table 650 corresponding to the compressed UV map 640. The 24 channels of 2D texture data illustrated by the UV map 610 are delineated by the UV map table 620 for different 3DGS components, such as location (P) (e.g., position coordinates x, y, z), opacity (O), rotation (R), scale(S), and color (C). The 12 channels of compressed 2D texture data illustrated by the compressed UV map 640 are delineated by the compressed UV map table 650 for different compressed 3DGS components (if applicable), such as compressed location (L′), compressed rotation (R′), compressed scale (S′), and compressed color (C′).

In some embodiments, as shown in FIGS. 5 and 6, there are 4 patches of size (256x256) that correspond to the rotation channels of a 3DGS scene. These 4 patches are shown with the squares with dotted line borders (e.g., R-1, R-2, R-3, and R-4) as illustrated by the UV map table 520, 620. This rotation data may be reshaped across pixels and represented as a single matrix R₂₅₆ₓ₂₅₆ₓ₄ to R_{65,535x4} where patches are vectorized across pixels. In an exemplary embodiment, a linear transform V̅ᵣ may be applied to the rotation patches R_{65,535x4} such that \tilde{R}=RV̅ᵣ, where Vᵣ is a 4×2 matrix and the low-rank rotation data \tilde{R} is obtained with dimensions 65,535x2. This computation reduces the number of rotation patches from 4 to 2 (e.g., R-1, R-2, R-3, R-4 in UV map table 520, 620 reduced to R-1′ and R-2′ in UV map table 550, 650). Similarly, the 12 color patches (e.g., C-1, C-2, C-3 . . . . C-12) as illustrated by the UV map table 520, 620) may be reduced to 4 patches (e.g., C-1′, C-2′, C-3′, and C-4′) in reduced data in the UV map table 550, 650.

In some implementations, a generalization of low-rank KL transforms across different 2D patches that represent the 3DGS data may be implemented. In some implementations, arbitrary values may be selected of N, M, K, and P for the compression scheme's 530, 630, indicating the number of KL (or eigen) bases to keep in the low-rank representation. For example, for location channels, a value of N=3 indicates the KL transform is lossless, meaning that the system does not throw any of the Eigen-bases corresponding to the location information after a KL transform. For color patches however, the system can select a smaller value for P=4 such that the texture of the 12 color components is reduced to 4 KL patches. In some implementations, different values for N, M, K, and P may be selected to have full or lower rank representations of the original 3DGS textures. This allows the techniques described herein to reduce the resolution of the data using KLTs and depending on the available bandwidth for transmission (e.g., a context of the transmission), acts as a rate-control mechanism. Smaller values of N, M, K, and P means that lower-rank approximations are needed, hence reducing the bitrate required to send the information over a channel at the cost of distortion in reconstructed 3DGS data, whereas larger values of N, M, K, and P may have smaller distortion after reconstructing the 3DGS model back but with increased bitrate requirements.

In some implementations, the transform matrices (e.g. KLT bases) can be trained offline from separate training data and can be reused for different scenes, avoiding the need for transmitting the basis vectors in the bitstream as supplemental enhancement information (SEI) messages. In some implementations, for non-static scenes or 3DGS scenes that are temporally changing similar to a video of a 3DGS scene, difference frames may be first computed prior to KL-transform and dimensionality reduction. For instance, a baseline or a fixed atlas may be subtracted temporally from each raw/derivative frame, and then KL transforms may be trained on the difference frames. In some implementations, the 2D representation of the 3DGS components may be temporally varying so there will be some redundancy between different patches across time. In this case, temporal prediction techniques can be applied including but not limited to temporal subtraction of frames from each other prior to compression.

In some implementations, one way to derive such a transform is via Singular Value Decomposition (SVD). SVD can decompose the original data as R=UᵣSᵣVᵣ^{T} where Vᵣ is a 4x4 full-rank matrix that defines the right singular vectors. By omitting the least important 2 basis vectors that correspond to smallest 2 eigenvalues in the diagonal of matrix Sᵣ, a dimensionality reduction transform based on KLTs may be achieved.

In some implementations, a motion compensation process using a global motion vector may be applied to a previously decoded frame to generate a reference for the current frame. The difference frame (e.g., a residual frame) between the current frame and its reference may be first computed prior to a KL-transform and dimensionality reduction. At the decoder side, the reference frames may be generated and then combined with the decoded residual frame to form the reconstructed frame. In some implementations, a global motion vector may be included as a translation motion and a rotation component. In some embodiments, the global motion may be included as a translation component only. In some embodiments, the global motion may include only a rotation part. In some embodiments, the reference frame index and the motion information of a frame may be signaled in SEI message. In some embodiments, all inter prediction techniques that apply to traditional video may apply to any raw or derivative version of the 2D patches that represents the 3DGS scene that varies over time.

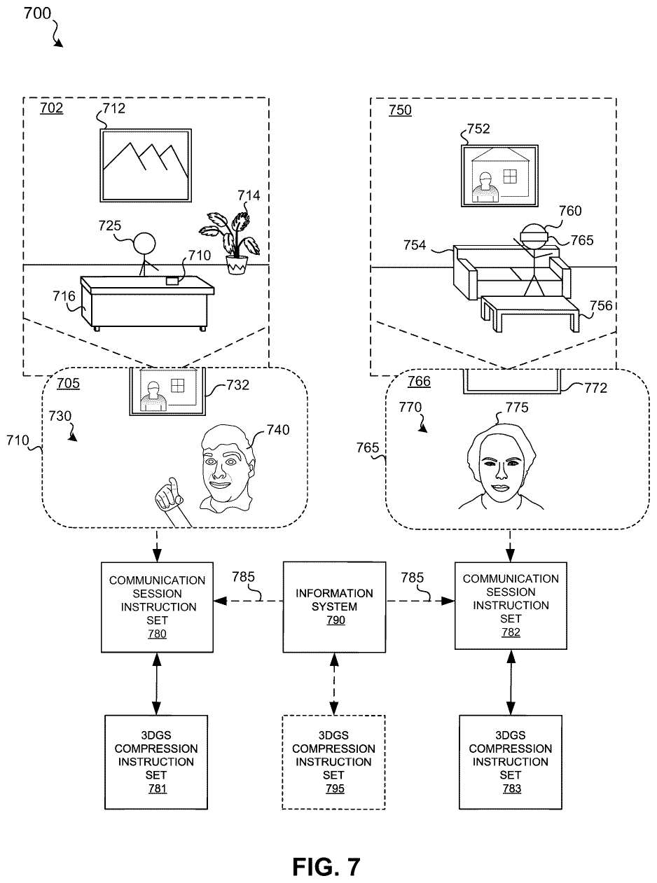

FIG. 7 illustrates exemplary electronic devices operating in different physical environments during a communication session of a first user at a first device and a second user at a second device with a view of a 3D representation of the second user for the first device in accordance with some implementations. In particular, FIG. 7 illustrates exemplary operating environment 700 of electronic devices 710, 765 operating in different physical environments 702, 750, respectively, during a communication session, e.g., while the electronic devices 710, 765 are sharing information with one another or an intermediary device such as a communication session system/server. In this example of FIG. 7, the physical environment 702 is a room that includes a wall hanging 712, a plant 714, and a desk 716 (e.g., physical environment 102 of FIG. 1). The electronic device 710 includes one or more cameras, microphones, depth sensors, or other sensors that can be used to capture information about and evaluate the physical environment 702 and the objects within it, as well as information about the user 725 of the electronic device 710 (e.g., a handheld device). The information about the physical environment 702 and/or user 725 may be used to provide visual content (e.g., for user representations) and audio content (e.g., for audible voice or text transcription) during the communication session. For example, a communication session may provide views to one or more participants (e.g., users 725, 760) of a 3D environment that is generated based on camera images and/or depth camera images of the physical environment 702, a representation of user 725.

Additionally, in this example of FIG. 7, the physical environment 750 is a room that includes a wall hanging 752, a sofa 754, and a coffee table 756. The electronic device 765 includes one or more cameras, microphones, depth sensors, or other sensors that can be used to capture information about and evaluate the physical environment 750 and the objects within it, as well as information about the user 760 of the electronic device 765 (e.g., a user worn device or HMD device, such as device 105). The information about the physical environment 750 and/or user 760 may be used to provide visual and audio content during the communication session. For example, a communication session may provide views of a 3D environment that is generated based on camera images and/or depth camera images (from electronic device 765) of the physical environment 750 as well as a representation of user 760 based on camera images and/or depth camera images (from electronic device 765) of the user 760. For example, a 3D environment may be sent by the device 710 by a communication session instruction set 780 in communication with the device 765 by a communication session instruction set 782 (e.g., via the information system 790 via network connection 785). The information system 790 may orchestrate the encryption/decryption and pre-downloading of an asset (e.g., 3D asset data, such as data associated with user representations 740, 775) between two or more devices (e.g., electronic devices 710 and 765).

FIG. 7 illustrates an example of a view 705 of a virtual environment (e.g., 3D environment 730) at device 710, where a representation 732 of the wall hanging 752 and a user representation 740 is provided (e.g., a persona of user 760), provided there is a consent to view the users' representations of each user during a particular communication session. In particular, the user representation 740 of user 760 is generated based on one or more user representation techniques for a more realistic persona generated in real time. The generation of user representations is further discussed herein.

Additionally, the electronic device 765 within physical environment 750 provides a view 766 that enables user 760 to view representation 772 of the wall hanging 712 and a representation 775 (e.g., a persona) of at least a portion of the user 725 (e.g., from mid-torso up) within the 3D environment 770. In other words, the user representation 740 of user 760 is generated at device 710 by generating combined 3D representations of the user 760 for the multiple instants in a period of time based on data obtained from device 765 (e.g., a frame-specific 3D representation of user 760). Alternatively, in some embodiments, user representation 740 of user 760 is generated at device 765 (e.g., sending device of a speaker) and sent to device 710 (e.g., viewing device to view a persona of the speaker). In some embodiments, each of the 3D representations 740 of user 760 and 775 of user 725 is generated by generating splats corresponding to user representation data and selected from among multiple sets of splats based on a context of a viewing experience according to techniques described herein.

In the example of FIG. 7, the electronic device 710 is illustrated as hand-held device and electronic device 765 is illustrated as a head-mounted device (HMD). However, either of the electronic devices 710 and 765 may be a mobile phone, a tablet, a laptop, so forth, or like electronic device 765, may be worn by a user (e.g., head-worn device (glasses), headphones, an ear mounted device, and so forth). In some implementations, functions of the devices 710 and 765 are accomplished via two or more devices, for example a mobile device and base station or a head mounted device and an ear mounted device. Various capabilities may be distributed amongst multiple device, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 710 and 765 may communicate with one another via wired or wireless communications. In some implementations, each device communicates with a separate controller or server to manage and coordinate an experience for the user (e.g., a communication session server). Such a controller or server may be located in or may be remote relative to the physical environment 702 and/or physical environment 750.

Additionally, in the example of FIG. 7, the 3D environments 730 and 770 are XR environments that are based on a common coordinate system that can be shared with other users (e.g., a virtual room for personas for a multi-person communication session). In other words, the common coordinate system of the 3D environments 730 and 770 are different than the coordinate system of the physical environments 702 and 750, respectively. For example, a common reference point may be used to align the coordinate systems. In some implementations, the common reference point may be a virtual object within the 3D environment that each user can visualize within their respective views. For example, a common center piece table that the user representations (e.g., the user's personas) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

In some implementations, the representations of each user may be realistic or unrealistic and/or may represent a current and/or prior appearance of a user. For example, a photorealistic representation of the user 725 or 760 may be generated based on a combination of live images and prior images of the user. The prior images may be used to generate portions of the representation for which live image data is not available (e.g., portions of a user's face that are not in view of a camera or sensor of the electronic device 710 or 765 or that may be obscured, for example, by a headset or otherwise). In one example, the electronic devices 710 and 765 are HMDs and live image data of the user's face includes a downward facing camera that obtains images of the user's cheeks and mouth and inward facing camera images of the user's eyes, which may be combined with prior image data of the user's other portions of the user's face, head, and torso that cannot be currently observed from the sensors of the device. Prior data regarding a user's appearance may be obtained at an earlier time during the communication session, during a prior use of the electronic device, during an enrollment process used to obtain sensor data of the user's appearance from multiple perspectives and/or conditions, or otherwise.

In some implementations, generating one or more user representations for a communication session as illustrated in FIG. 7 (e.g., generating user representation 740, 775), may be based on one more rendering techniques, such as using a 3D mesh or a 3D point cloud. However, techniques described herein utilize a 3D gaussian splat rendering approach using UV mapping. In particular, the communication session instruction set 780 and the communication session instruction set 782 may each include a 3DGS compression instruction set 781, 783, respectively, for generating compressed versions of 3DGS data that represents at least a portion of an object (e.g., a persona) based on a compression scheme (e.g., KL transforms or other generic learned transforms), according to one or more techniques described herein. In other words, the device 710 compresses 3DGS data associated with the user 740 and sends the compressed 3DGS data to the device 765 which decompresses the 3DGS data before rendering the persona (e.g., user representation 775). In some implementations, the compression techniques may be performed by a 3DGS compression instruction set 795 as part of the information system 790 (e.g., compression performed by an external system/server).

Several advantages may be realized using a simple set of values with depth values defined relative to multiple points as expressed by 3D Gaussian splats using UV mapping and compressing/decompressing the data. The set of values may require less computation and bandwidth than using a 3D mesh or 3D point cloud, while enabling a more accurate user representation than an RGBDA image. Moreover, the set of values may be formatted/packaged in a way that is similar to existing formats, e.g., RGBDA images, which may enable more efficient integration with systems that are based on such formats. Furthermore, the 3DGS compression may be configured to facilitate bitrate allocations corresponding to different network bandwidth conditions associated with the information system 790 via network connection 785, e.g., using more bandwidth when available or needed based on the context, such as a context associated with the rendering (e.g., quality constraints), and the like.

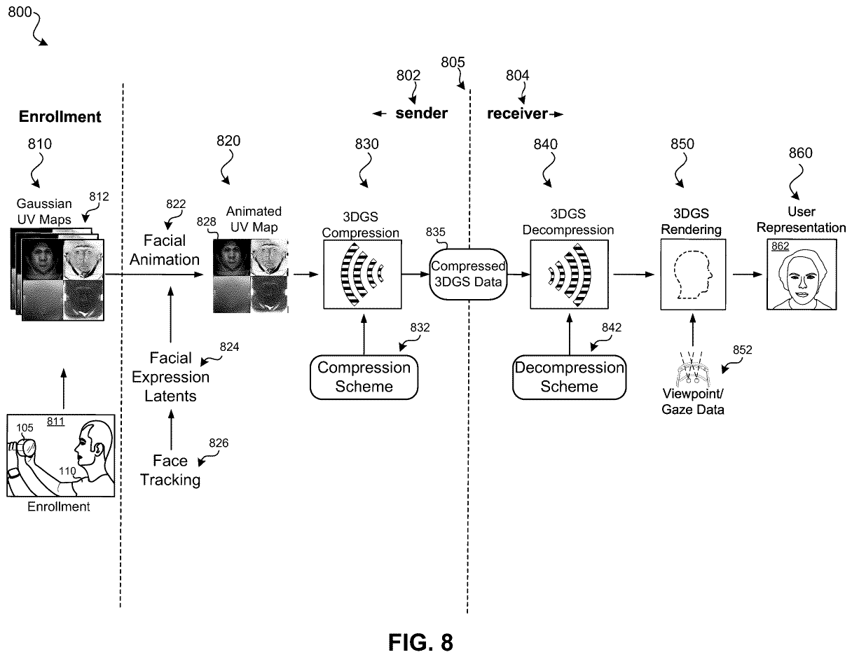

FIG. 8 illustrates an example of generating a representation of a user (e.g., a persona) by rendering splat parameter data using a 3DGS compression scheme in accordance with some implementations. In particular, FIG. 8 illustrates an example user representation process 800 for obtaining compressed 3DGS data from a sending device (e.g., user representation data of a sender-a persona) and a viewpoint at a receiving device for a viewer to generate a view of a user representation using a Gaussian splatting technique after decompressing the 3DGS data. Moreover, the example rendering process of user representation process 800 of FIG. 8 illustrates a data flow process between the sending device (e.g., sender phase 802) and the receiving device (e.g., receiver phase 804) as illustrated by the send/receive timeline mark 805.

Enrollment process 810 illustrates generating Gaussian UV map data 812 based on obtaining images of a user (e.g., user 110 of FIG. 1) during an enrollment process. An enrollment process 810 may include a user enrollment registration (e.g., preregistration of enrollment data) and obtaining sensor data (e.g., live data enrollment). The user enrollment registration, as illustrated in image 811, may include a user (e.g., user 110), obtaining a full view image of his or her face using external sensors on the device 105, and therefore, would take off and orient the device 105 (e.g., an HMD) towards his or her face during an enrollment process. The enrollment personification may be generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. An enrollment personification preview may be shown to the user while the user is providing the enrollment images to get a visualization of the status of the enrollment process. The enrollment image data may include an enrollment personification with different user expressions and from different viewpoints. In some examples, more or less different expressions and/or viewpoints may be utilized to acquire sufficient data for the enrollment process.

In some implementations, a transformation of the enrollment image data to feature data may occur by transforming (e.g., via a transformer) as part of a feature data process before generating the Gaussian UV map data 812. For example, feature data may include learned feature information of the user 110 obtained from the enrollment images, such as skin, color, and other semantic information per pixel. The feature data may include a list of positions for each feature value (e.g., 14 feature channels). The feature data may then be decoded by a decoder to generate 3D Gaussian map data 812 for each feature as part of a Gaussian map process. The 3D points of the feature data may be mapped to Gaussian parameters of a UV map (e.g., 3D points+Gaussian parameters) to generate multiple 3D Gaussian maps as 3D Gaussian map data 812 to be rendered by a specific splat generation technique (e.g., model/parameters specifying total number of splats, splat size attributes, etc. for different resolutions). For example, a UV map stores the x,y,z positions for the splat parameters (e.g., direction and angle information (cone of visibility information), color (view dependent/harmonics information), covariance, alpha/transparency, orientation, opacity, extent in each axis, rotation, scale, semantic information (e.g., skin, hair, cheek, nose, lips, eyebrow, etc.). In other words, the Gaussian map process of the enrollment process 810 may obtain 3D point information that includes sufficient information that which splat generation can be generated (e.g., 3D vector projections).

After the enrollment process for generating the initial 3D Gaussian map data 812 associated with a user (e.g., a sender), the process 800 proceeds to generating animated 3DGS data (e.g., live data), that may be compressed and used during a communication session (e.g., generating a live persona based on real time data). Thus, during a live data process 820, an animated UV Map of 3DGS data 828 for a frame may be generated based on obtaining live data of a portion of the sender (e.g., the face, head, and/or upper torso of the sender). For example, facial animation data 822 may be determined based on facial expression latents data 824 and face tracking information 826. In particular, the live data process 820 captures head/face tracking data and body tracking data (e.g., real-time sensor data for the user to update the user representation). The head/face tracking data may be used to identify expression latents 824 and head pose data (e.g., HMD-to-Head pose information) based on face tracking information 826. The facial expression latents 824 may be used for the animation and decoding process with identity latents for updating the Gaussian UV map data 812 from enrollment with the current (“live”) facial expressions of the user (e.g., animated facial expressions).

After determining one or more frames of animated UV map of 3DGS data 828 from the live data process 820, the process 800 proceeds to the 3DGS compression process 830 that determines the compressed 3DGS data 835 based on a compression scheme 832 according to one or more compression techniques described herein (e.g., KL-transforms or other generic learned transforms, rate control with QP modulation, and the like). The compressed 3DGS data 835 is then sent to a receiving device for decompression and rendering. For example, the process 800 proceeds to the 3DGS decompression process 840 that decompresses the compressed 3DGS data 835 based on a decompression scheme 842 according to one or more compression techniques described herein.

In some implementations, parameters of the compression scheme such as the trained KLT weights, position of 3DGS channels information in a given atlas may be signaled in a standard complaint bitstream as SEI message. In this case, the decompression scheme can parse such message and decompress and interpret information accurately. Additionally, or alternatively, in some implementations, any information regarding the compression scheme can be signaled with standard codecs such as HEVC, VVC, AV1, AV2.

Additionally, or alternatively, in some implementations, a standard codec may have a specialized coding tool to encode latent space information such as properties of the 3DGS textures, location, and relative QP allocation. For example, such information can be signaled on the bitstream in sequence header, picture header, slice header, or other high-level syntax that expresses the availability of lower-level 3DGS information in the bitstream. Consequently, based on the high-level signaling other low level signaling that pertains to 3DGS data may be present in the bitstream at superblock, macroblock, coding unit or transform unit level.

In some implementations, the process 800 proceeds after decompressing the 3DGS data during the 3DGS decompression process 840 to the 3DGS rendering process 850 at a receiving device (e.g., at a viewer's device). For example, the system (e.g., at viewer's device) obtains the animated UV Map of 3DGS data 828 (e.g., the feature data mapped to Gaussian parameters via a UV map) after decompression, and projects the Gaussian data using a current viewpoint (e.g., viewpoint data 852) to determine 2D Gaussian map data (e.g., 2D points+Gaussian parameters) for the 3DGS rendering process 850 at a receiving device. In other words, a receiving device obtains multiple sets of splats that include 3D Gaussian data that may be rendered based on a current viewer's viewpoint. After the 3DGS rendering process 850, then Gaussian splatting may be used for the rendering to generate a view of a user representation for the user representation generation process 860. For example, a 3D Gaussian splatting technique uses the 2D points from a map (e.g., a UV map) and the associated Gaussian parameters to render an image using Gaussian splatting based on the current viewpoint of the viewer (e.g., viewpoint and gaze data 852). The rendering of the user representation 862 is illustrated as a user representation (e.g., a persona), but the Gaussian splatting techniques described herein may be used for any 3D object or 3D scene reconstruction.

In some implementations, the compression scheme 832, the corresponding decompression scheme 842, and the amount of compression (e.g., a quantization parameter (QP) allocation scheme) may be configured (smaller or greater) based on a context. For example, the compression may be configured to facilitate bitrate allocations corresponding to different network bandwidth conditions, e.g., using more bandwidth when available or needed based on the context. The context may be associated with the rendering (e.g., quality constraints), the communication session parameters, and the like. In some embodiments, smaller QP values (e.g., less compression) may be applied to particular regions (e.g., mouth/eye regions).

In some implementations, a splat rendering approach (e.g., a rendering mode) may be selected during the 3DGS rendering process 850. For example, a context analyzer may identify a compression scheme and/or a splat rendering model (e.g., high resolution versus a lower resolution splat model) based on sensor data of a viewing environment, which may include the viewpoint/gaze data 852 of the viewer, and data associated with the sender (e.g., bitrate allocations, network constraints, and the like). For example, user/scene understanding information may be obtained to determine different contexts, such as, inter alia, identifying a viewpoint distance, determining whether the user capturing a picture/video, speaking to a specific persona, saying the name of a user represented by a persona in the user's field of view, and the like. In some implementations, a viewing experience may be an experience in which a view of a representation of the at least the portion of the object will be rendered based on a viewpoint in a 3D environment. For example, a scene understanding of a physical environment may be obtained or determined by the device 105 based on depth data and light intensity image data. For example, a user 110 may scan the environment that he or she is located in, and based on the image data (e.g., light intensity and/or depth), a scene understanding instruction set may determine information for the physical environment (e.g., objects, people within the environemnt, etc.) to track object-based data based on generating a scene understanding of the environment. Additionally, a user/scene understanding may be used to determine a context of the experience and/or the environment (e.g., create a scene understanding to determine the objects or people in the content or in the environment, where the user is, what the user is watching, etc.). The sender data may include additional context data that may be used by the context analyzer to determine a splat rendering approach (e.g., a sender or a sender's device may send information that requires a higher resolution splat rendering, i.e., to take a picture or have a higher resolution for a certain persona (among other personas in the environment) that the user is interacting/speaking with during a communication session).

In some implementations, a context analyzer may determine a context of the viewing experience based on one or more different criterion and may continuously update the determined context such that the compression scheme and/or the splat rendering approach and may be updated frame to frame. In some implementations, a context of a viewing experience may be based on a distance to a user (e.g., a user can see more detail of personas up close than far away, and those personas are more likely to be interacting with the user). In some implementations, a context of a viewing experience may be based on a detected user speech (e.g., user speaks name of a certain persona which will cause that persona to be rendered at a high resolution). In some implementations, a context of a viewing experience may be based on detected speech of persona speaking to the user (e.g., a persona could say user's name and start talking about something and the rendering approach would change to a higher resolution). In some implementations, a context of a viewing experience may be based on detected user intent to communicate with a certain persona and/or sensor fusion (e.g., gaze and spoken word and hand gestures). For instance, if a persona is not interacting with the user, then the persona may be switched to be rendered at a lower resolution and/or may be more compressed, but then when a persona speaks a user's name indicating that he/she wants to interact with the user, the persona may still be rendered at a lower resolution until the user gazes over at the persona that spoke the user's name. Thus, in an exemplary implementation, the resolution modifications that are continuously updated during a viewing experience based on the context may be modified based on one more 3D gaussian specific parameters (e.g., variance, size, color, etc.).

In some implementations, the compression schemes and splat rendering approach for generating the user representation 862, may vary and may be adjusted based on resolution, different size of splats, different colors or less color spectrums, different number of gaussians rendered along a viewing ray 230, or a combination thereof. For example, as illustrated in FIG. 2C, a high-resolution splat rendering technique can render more gaussian splats along the viewing ray 230 while a lower resolution can render may be only the first and/or second splat. In some implementations, a lower resolution splat rendering technique may use proxy rendering. The various implementations discussed herein for each splat rendering technique to generate different versions of quality of representations (e.g., low to high resolution) are merely exemplary and is not meant to be limiting. For example, other embodiments may have more or less than three different levels of resolution (e.g., low, medium, high, etc.), and some embodiments may not have discrete levels and may have a continuous, sliding bar approach that may be adjusted based on the context of the viewing experience as it may change frame-to-frame.

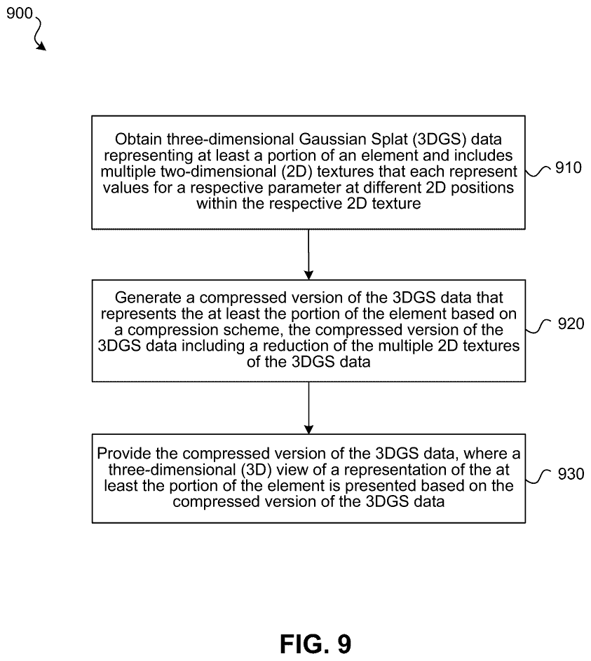

FIG. 9 is a flowchart illustrating an exemplary method 900. In some implementations, a device (e.g., device 105 of FIG. 1) performs the techniques of method 900 to provide a compressed version of 3DGS data using a compression scheme in accordance with some implementations. In some implementations, the techniques of method 900 are performed on a mobile device, desktop, laptop, HMD, or server device. In some implementations, the method 900 is performed on processing logic, including hardware, firmware, software, or a combination thereof. In some implementations, the method 900 is performed on a processor executing code stored in a non-transitory computer-readable medium (e.g., a memory). In some implementations, the method 900 is implemented at a processor of a device, such as a viewing device, that renders the user representation (e.g., device 710 of FIG. 7 renders 3D representation 740 of user 760 (a persona) from data obtained from device 765).

At block 910, the method 900, at a processor of a device, obtains 3DGS data representing at least a portion of an element and includes multiple 2D textures that each represent values for a respective parameter at different 2D positions within the respective 2D texture. The respective 2D texture that represents values for a respective parameter at different 2D positions is provided such that pixel values of each 2D texture (e.g., at particular locations within the texture) correspond to values of the respective parameter for corresponding portions of the element that is represented. For example, UV maps of 3DGS data are generated for an element or object (such as a person when generating personas).

In some implementations, the 3DGS data includes 3D Gaussian parameters. For example, the 3DGS data may include position information (e.g., a 3D position), direction and angle information (e.g., a cone of visibility), color information, covariance information, transparency information, an orientation, opacity information, extent information in each axis, rotation data, a scale, and/or semantic information (e.g., skin, hair, cheek, nose, lips, eyebrow, etc.). For example, as illustrated in FIG. 8, the 3D Gaussian map process generates 3D Gaussian UV Map data 812 (e.g., multiple sets of 3DGS data) by transforming the enrollment image data to multiple sets of feature data which may include learned feature information of a user obtained from the enrollment images, such as skin, color, and other semantic information per pixel. For example, a splat parameter position may identify where a splat is located based on xyz coordinates, a splat parameter covariance may identify how a splat is stretched/scaled (e.g., a 3×3 matrix), a splat parameter color may identify an RGB color, and a splat parameter alpha (α) may identify how transparent is the splat. In some implementations, the user representation data includes 3D point cloud points associated with distribution data defining sizes and shapes for rendering 3D point cloud points as splats. For example, a splat model generated using Gaussian splats that includes texture/color, position, splat shape, and the like. In some implementations, the user representation data includes 3D mapping information that includes feature values and position information for each map point (e.g., identifying x,y,z positions corresponding to UV coordinates of a UV map).

At block 920, the method 900 generates a compressed version of the 3DGS data that represents the at least the portion of the element based on a compression scheme, the compressed version of the 3DGS data including a reduction of the multiple 2D textures of the 3DGS data. For example, compression techniques may be used to reduce a number, a size, or data used associated with the obtained 3DGS data. The compression techniques (e.g., KL transforms or other generic learned transforms) may be based on KL-transforms for location (L), Rotation (R), Scale(S), and Color SH (C), or the 3DGS parameters. Moreover, the compression may be scalable across different bitrate targets (e.g., different network constraints).

In some implementations, each of the 3D splats are associated with a particular splat parameter type of a plurality of splat parameter types (e.g., location (L), Rotation (R), Scale(S), and Color (C)). In some implementations, the plurality of splat parameter types includes at least one of a location, a rotation, a scale, a color, and an opacity. In some implementations, generating the compressed version of the 3DGS data based on the compression scheme includes selecting one or more the plurality of splat parameter types, and applying the compression scheme using the selected one or more the plurality of splat parameter types. For example, given a bitrate for a network connection, a suitable number of components (parameter types) may be selected to keep, but then apply different QPs to other components. For example, as illustrated in FIG. 5, the location blocks (P-1, P-2, P-3) and opacity block (O-1) are not compressed, but the rotation blocks (R-1, R-2, R-3, R-4), scale blocks (S-1, S-2, S-3), and color blocks (C-1, C-2, C-3 . . . . C-12) are compressed. In other words, the system may provide an optimization of a “scalable” rate of transmission and quality of playback according to different network bandwidth characteristics and quality requirements for rendering a view of the element.

In some implementations, the compression scheme is determined based on a network bandwidth condition. For example, the compression may be configured to facilitate bitrate allocations corresponding to different network bandwidth conditions, e.g., using more bandwidth when available or needed based on the context. Additionally, or alternatively, in some implementations, the compression scheme is determined based on a context associated with providing (e.g., transmitting) the compressed version of the 3DGS data. For example, the compression may be configured as needed based on the context, such as a context associated with the rendering (e.g., quality constraints), may be based on the sender's and/or the viewer's respective environments, and the like.

In some implementations, the compressed version of the 3DGS data includes a reduction in at least of a number, a size, and an amount of data associated with the multiple 2D textures of the 3DGS data (e.g., reducing the number, size, or data transmitted).

In some implementations, the compression scheme includes a machine learned method, a neural network, or a compression mapping algorithm. For example, a machine learning model may be trained to assign different QP values to each patch to maximize the final reconstructed 3DGS scene after decompression and inverse mapping from 2D to 3D. In some implementations, different mappings (other than KL-transforms) that can reduce the number of channels of the original data by using more sophisticated approaches by using multiple linear or non-linear layers than can constitute a neural network. Such layers or networks may be trained to reduce the dimensions of the data with distortion metrics other than the mean squared error). In some implementations, the compression scheme is a dimensionality-reduction transform. In some implementations, the dimensionality-reduction transform is a Karhunen-Loeve (KL) transform. For example, KL-transforms, or similar dimensionality-reduction transforms, are transforms that are used to achieve dimensionality reduction (e.g., compression) or to re-organize data using a set of eigenbases that best represent the data.

In some implementations, generating the compressed version of the 3DGS data that represents the at least the portion of the element is based on identifying particular regions of the element, where the compressed version of the 3DGS data includes the reduction of the multiple 2D textures of the 3DGS data associated with the identified particular regions of the element at a rate that is different (less compression) than other regions of the element. For example, as discussed herein for the rate control and QP modulation process 440 in FIG. 4, smaller QP values (less compression) may be applied to particular regions (e.g., mouth/eye regions) compared to using larger QP values (more compression) for other regions (e.g., hair, upper torso, or other areas that may not move during a communication session). For example, each low-rank 2D KL-patch may be divided into coding blocks with smaller squares, and in the particular areas that may require or be desired to have less compression, a smaller QP value may be applied and quantized less aggressively since these finer regions may contain important information compared to other coding blocks that are not marked (e.g., mouth/eye regions move during a communication session and may require more less compression to improve the rendering quality).

At block 930, the method 900 provides the compressed version of the 3DGS data, where a 3D view of a representation of the at least the portion of the element is presented based on the compressed version of the 3DGS data. The 3D view of the representation of the at least the portion of the element may be presented at the same device that compressed the 3DGS data, or may be presented at a different device. For example, as illustrated in FIG. 8, a sending device sends compressed 3DGS data 835 to a receiving device, which in turn, decompresses the 3DGS data and provides a view of a user representation 862.

In some implementations, the 3D view of the representation of the at least the portion of the element is presented for multiple frames corresponding to successive instants in time and is used (streamed) to provide a time-varying view of the element. In some implementations, providing the view includes rendering a subset of splats based on the splat parameter data. For example, Gaussian splatting may be used to avoid or fill holes in the rendering. In some implementations, the at least the portion of the element includes a face portion and an additional portion of a user (e.g., head, neck, clothes, hair, body, etc. of user of a sending device). For example, body pose data may be applied during the live data process 820 for the animated UV map of 3DGS data 828 in FIG. 8 to render the neck and shoulder regions for a persona rendering. Additionally, in some implementations, the selected subset of splats may be reused in subsequent frames if the characteristic (e.g., a viewpoint-viewpoint data 852) does not change.

In some implementations, the method 900 further includes providing (e.g., transmitting) the compressed version of the 3DGS data to a different device to generate (e.g., rendering) the view of the representation of the at least the portion of the element, wherein the different device decompresses the compressed version of the 3DGS data based on the compression scheme. In some implementations, the device is a sender's device, where the compression scheme is selected based on data obtained during a communication session with a viewer's device associated with the view of the representation of the at least the portion of the element. For example, as illustrated in FIG. 7, user representation data (e.g., 3DGS data) is compressed and transmitted for display during live a communication session. In some implementations, a sender's device (e.g., device 710), a viewer's device (e.g., device 765), a network server (e.g., information system 790), or a combination thereof, provides parameter data for the determined compression scheme (e.g., network constraints, other context data associated with the rendering, and the like).

In an exemplary implementation, as illustrated in FIG. 8, the device is a sending device that sends viewing device that renders a representation of at least a portion of the element, such as a user representation (e.g., a persona). In some implementations, the at least the portion of the element (e.g., an object, such as a person) includes a face portion and an additional portion of the user (e.g., head, neck, clothes, hair, body, etc. of a user of sending device). In other words, the method 900 is at a viewer's device that provides a view of a representation of a sender based on data from a sender's device. In an exemplary implementation, a user representation (e.g., a persona) of the sender is provided for viewing, however, the techniques described herein (e.g., Gaussian splatting culling) may render any type of object or scene for reconstruction of viewing at the viewer's device.

In some implementations, the user representation data is based on UV maps and 3D point cloud points associated with distribution data defining sizes and shapes for rendering the 3D point cloud points as splats corresponding to each point of the UV maps (e.g., 3D Gaussian map). For example, as illustrated in FIG. 8, the user representation 862 may be generated for a particular viewpoint based on rendering the points from decompressed animated UV map of 3DGS data 828 after a 3DGS rendering process 850.

In some implementations, the method 900 further includes determining a context of a viewing experience. For example, user/scene understanding information may be obtained to determine different contexts, such as, inter alia, identifying a viewpoint distance, determining whether the user capturing a picture/video, and the like. In some implementations, a viewing experience may be an experience in which a view of a representation of the at least the portion of the object will be rendered based on a viewpoint in a 3D environment. For example, a scene understanding of a physical environment may be obtained or determined by the device 105 based on depth data and light intensity image data. For example, a user 110 may scan the environment that he or she is located in, and based on the image data (e.g., light intensity and/or depth), a scene understanding instruction set may determine information for the physical environment (e.g., objects, people within the environment, etc.) to track object-based data based on generating a scene understanding of the environment. For example, a scene understanding may be used to more accurately track the movements of the user 110 relative to the environment. Additionally, a scene understanding may be used to determine a context of the experience and/or the environment (e.g., create a scene understanding to determine the objects or people in the content or in the environment, where the user is, what the user is watching, etc.).

In some implementations, the context of the viewing experience includes a viewpoint of the view of the representation and selecting a compression scheme and/or a splat rendering approach for use in providing a view is based on a threshold distance associated with the viewpoint. For example, use more compression (e.g., a lower quality set of splats generated using a 32K splat model) when the viewpoint is more than a threshold distance away, and use less compression (e.g., a higher quality set of splats generated using a 64K splat model) when the viewpoint is less than the threshold. Additionally, or alternatively, in some implementations, the context of the viewing experience includes recording of at least one frame of content associated with a viewpoint of the view of the representation and selecting the compression scheme for use in providing a view is based on the recording of the at least one frame of content. For example, use less compression and/or select a 64K splat model with the viewer is capturing a picture/video.

In some implementations, a context analyzer determines a context of the viewing experience based on one or more different criterion and may continuously update the determined context such that the splat rendering approach and may be updated frame to frame. In some implementations, a context of a viewing experience may be based on a distance to a user (e.g., a user can see more detail of personas up close than far away, and those personas are more likely to be interacting with the user). For example, a representation may be shown in a higher detail/resolution because it is closer to the viewpoint of a viewer. In some implementations, a context of a viewing experience may be based on a detected user speech (e.g., user speaks name of a certain persona which will cause that persona to be rendered at a high resolution). For example, a representation may be shown in a higher detail/resolution because a speaker is speaking towards the viewer.

In some implementations, a context of a viewing experience may be based on detected speech of persona speaking to the user (e.g., a persona could say user's name and start talking about something and the compression scheme and/or rendering approach may change to less compression and/or a higher resolution). In some implementations, a context of a viewing experience may be based on detected user intent to communicate with a certain persona and/or sensor fusion (e.g., gaze and spoken word and hand gestures). For instance, if a persona is not interacting with the user, then the persona may be switched to be more compressed and/or rendered at a lower resolution, but then when a persona speaks a user's name indicating that he/she wants to interact with the user, the persona may still be rendered at a lower resolution until the user gazes over at the persona that spoke the user's name. Thus, in an exemplary implementation, the compression scheme and/or resolution modifications may be continuously updated during a viewing experience based on the context (e.g., bitrate allocations, quality constraints associated with the rendering, and the like) and may be modified based on one more 3D gaussian specific parameters (e.g., variance, size, color, etc.).

In some implementations, a receiving device provides the view of the representation of the at least the portion of the element (e.g., after decompression) based on a selected splat rendering approach and renders a subset of splats based on the 3DGS data. For example, a selected splat rendering approach (e.g., selecting a rendering mode, such as, a high resolution versus a lower resolution rendering) may be used to render a view of a user presentation (e.g., a persona), or a rendering of another object or a scene. Furthermore, 3D Gaussian splatting may be used to avoid or fill holes, body pose data may be applied to include additional areas of the user (e.g., neck/shoulder area). For example, as illustrated in FIG. 8, a user representation 862 is generated for a particular viewpoint (e.g., viewpoint data 852) based on rendering the points from the decompressed data associated with the animated UV map of 3DGS data 828, which combines the obtained Gaussian UV map data 812 from enrollment, and updated (e.g., live data) for each frame based on one or more marker points (e.g., a set of semantic points associated with facial features or other areas corresponding to the sender associated with a rendered user representation 862).

In various implementations, the selected compression scheme and/or splat rendering approach may be reused (e.g., rerendered) in subsequent frames if the characteristic (e.g., viewpoint) does not change. In some implementations, the view of the representation is provided for a first frame of a plurality of frames for a first viewpoint, the method 900 further including, for a second viewpoint for a second frame of the plurality of frames determining that the second viewpoint is equivalent to the first viewpoint, and reusing the view of the representation of the at least the portion of the object from the first frame for the second frame (e.g., based on the selected splat approach form the first frame). Additionally, or alternatively, in some implementations, the view of the representation is provided for a first frame of a plurality of frames for a first viewpoint, the method 900 further including, for a second viewpoint for a second frame of the plurality of frames determining that the second viewpoint is different than the first viewpoint, selecting a different splat rendering approach (e.g., improving or diminishing the quality of the rendering) based on a context of a viewing experience associated with the second frame (e.g., a viewer's perceived distance changes, another attribute of the context changes, etc.), and updating the view of the representation of the at least the portion of the object based on the different splat rendering approach.

In various implementations, the method 900 further includes modifying the user representation data based on obtaining a set of sensor data obtained after an enrollment process. For example, modifying the splat parameter data based on live user data. For example, the splat parameter data may be obtained from a sending device such as from an enrollment process, and the modifications to the enrollment splat parameter data may be based on obtaining live sensor of the sender in order to determine a live representation of the sender (e.g., a live view of a realistic persona for a communication session). In some implementations, modifying the user representation data generates 3D Gaussian splats based on the image data for the at least the portion of the user, where the Gaussian splats include a texture, a position, and a splat shape. For example, a 3D Gaussian distribution in 2D space with color/density, e.g., parameterization where a face is represented as a grid, and the system determines a number or splats per ray off the face/grid. In some implementations, the splat generation technique generates a user representation via a machine learning model trained using training data obtained via one or more sensors in one or more environments. For example, a machine learning model that interprets the image data and/or other sensor data captured during enrollment.

In various implementations, the user representation data may be modified for a face and not the body, for a body and not the face, both the body and face, and/or may be modified either during an enrollment phase, on a sender side device and/or on a receiver side device. In other words, the user representation (persona) may be continuously updated to represent a live view of a current user's head/face and/or upper body movements and may be modified at different stages during a communication session. In some implementations, the compression scheme and/or the splat rendering approach associated with the user representation data is modified based on body pose data obtained during the enrollment process, during a communication session with another device, or a combination thereof. In some implementations, the device is a viewer's device, and the splat rendering approach associated with the user representation data is modified based on an additional set of sensor data obtained during a communication session with a sender's device associated with the user representation. Alternatively, in some implementations, the splat rendering approach associated with the user representation data is generated and updated during the enrollment process based on images of a face of the user captured while the user is expressing a plurality of different facial expressions (e.g., enrollment images of the face while the user is smiling, brows raised, cheeks puffed out, etc.).

In some implementations, a second set of sensor data may be obtained after the enrollment process by the device (e.g., a viewer's device), such as the facial animation data 822. The facial animation data 822 may include a sequence of frames for determining the animated UV map of 3DGS data 828 and corresponding marker points. The sequence of frames for the Gaussian UV Map and corresponding marker points may be compressed and obtained during a communication session from a second device (e.g., a sender's device). The device (e.g., a viewer's device) decompressed the compressed 3DGS data 835 and renders an animated depiction of the user (e.g., a sender) based on the sequence of frames for a Gaussian UV Map and corresponding marker points (e.g., animated UV map of 3DGS data 828) using one or more splatting techniques described herein. For example, the decompressed 3DGS data sent during a communication session with a second device may be used to render a view of the face (and upper body) of the user (sender). Additionally, or alternatively, sequential frames of face data (appearance of the user's face at different points in time) and body tracking data may be transmitted and used to display a live 3D video-like depiction of the user (e.g., a “live” persona).

In some implementations, the second user representation is based on second image data obtained via a second set of sensors in a second physical environment having a second lighting condition (e.g., different lighting condition than the first physical environment). For example, during an enrollment process, the user representation data is acquired in a particular environment (also referred to herein as an “enrollment environment”) that includes some lighting conditions information (e.g., luminance values and other lighting attributes), which may be different lighting data than live lighting data (e.g., two different physical environments between enrollment and during the generation of the persona based on “live” sensor data). In some implementations, providing the view of the representation of the at least the portion of the object based on the selected splat rendering approach includes displaying the representation in in a 3D environment, such as an extended reality (XR) environment. In some implementations, the 3DGS data is obtained in a first physical environment, and the 3D view of the representation of the at least the portion of the element is displayed in a view of a second physical environment that is different than the first physical environment.

In some implementations, the user representation data of at least a portion of a user that is obtained during an enrollment process is based on images of a face of the user captured in different poses, and/or while the user is expressing a plurality of different facial expressions. For example, the images are enrollment images of the face while the user is facing toward the camera, to the left of the camera, and to the right of the camera, and/or while the user is smiling, brows raised, cheeks puffed out, etc. For example, as illustrated by enrollment process 810 of FIG. 8, enrollment images of the face may be obtained while the user is smiling, brows raised, cheeks puffed out, etc. from different viewpoints. In some implementations, the first set of sensor data corresponds to only a first area of the user (e.g., parts not obstructed by the device, such as an HMD), and the second set of sensor data corresponds to a second area including a third area different than the first area. For example, a second area may include some of the parts obstructed by an HMD when it is being worn by the user. For example, during an enrollment process, a larger portion of a user may be captured by image data (e.g., not wearing the HMD), than during a live communication session with the user wearing the HMD.

In some implementations, as illustrated in FIG. 7, the rendering occurs during a communication session in which a second device (e.g., device 765) captures sensor data (e.g., image data of user 760 and a portion of the environment 750) and provides a sequence of frame-specific 3D representations corresponding to the multiple instants in the period time based on the sensor data. For example, the second device 765 provides/transmits the sequence of frame-specific 3D representations to device 710, and device 710 generates the combined 3D representation to display a live 3D video-like face depiction (e.g., a realistic moving persona) of the user 760 (e.g., representation 740 of user 760). Alternatively, in some implementations, the second device provides the 3D representation of the user (e.g., representation 140 of user 760) during the communication session (e.g., a realistic moving persona). For example, the combined representation is determined at device 765 and sent to device 710. In some implementations, the views of the 3D representations are displayed on the device (e.g., device 710) in real-time relative to the multiple instants in the period of time. For example, the depiction of the user is displayed in real-time and based on live lighting data (e.g., a persona shown to a second user on a display of a second device of the second user).

In some implementations, the compressed 3DGS data 835 may include sufficient data to enable a stereo view of the user (e.g., left/right eye views) such that the face may be perceived with depth. In one implementation, a depiction of a face includes a 3D model of the face and views of the representation from a left eye position and a right eye position and are generated to provide a stereo view of the face. In some implementations, certain parts of the face that may be of importance to conveying a realistic or honest appearance, such as the eyes and mouth, may be compressed and/or generated differently than other parts of the face (e.g., based on marker points). For example, parts of the face that may be of importance to conveying a realistic or honest appearance may be based on current camera data while other parts of the face may be based on previously-obtained (e.g., enrollment) face data.

In some implementations, a representation of a face is generated with texture, color, and/or geometry for various face portions identifying an estimate of how confident the generation technique is that such textures, colors, and/or geometries accurately correspond to the real texture, color, and/or geometry of those face portions based on the depth values and appearance values each frame of data. In some implementations, the depiction is a 3D persona. For example, the representation is a 3D model that represents the user (e.g., user 110 of FIG. 1).

In some implementations, the 3DGS data is determined from obtained sensor data (e.g., live data, such as video content that includes light intensity data (RGB) and depth data), that is associated with a point in time, such as images from inward/down facing sensors while the user is wearing an HMD associated with a frame. In some implementations, the sensor data includes depth data (e.g., infrared, time-of-flight, etc.) and light intensity image data obtained during a scanning process. In some implementations, the 3DGS data is determined from obtaining sensor data during an enrollment process which may include obtaining enrollment sensor data corresponding to features (e.g., texture, muscle activation, shape, depth, etc.) of a face of a user in a plurality of configurations from a device (e.g., enrollment images of FIG. 8). In some implementations, a first set of data includes unobstructed image data of the face of the user. For example, images of the face may be captured while the user is smiling, brows raised, cheeks puffed out, etc. In some implementations, enrollment data may be obtained by a user taking the device (e.g., an HMD) off and capturing images without the device occluding the face or using another device (e.g., a mobile device) without the device (e.g., HMD) occluding the face (e.g., image 811). In some implementations, the enrollment data is acquired from light intensity images (e.g., RGB image(s)). The enrollment data may include textures, muscle activations, etc., for most, if not all, of the user's face. In some implementations, the enrollment data may be captured while the user is provided different instructions to acquire different poses of the user's face. For example, the user may be instructed by a user interface guide to “raise your eyebrows,” “smile,” “frown,” etc., in order to provide the system with a range of facial features for an enrollment process.

In some implementations, the method 900 for 3DGS data compression may be repeated for each frame captured during each instant/frame of a live communication session or other experience. For example, for each iteration, while the user is using the device (e.g., wearing the HMD), the method 900 may involve continuously obtaining live sensor data (e.g., face tracking data, body tracking, and the like), and for each frame, compressing the 3DGS data and sending the compressed 3DGS data to a receiving device. The receiving device (e.g., a viewer's device) may then decompress the data and update the rendering based on updated viewing characteristics (e.g., FoV, gaze, occlusions, etc.) for that frame, and update the displayed portions of the user representation based on the updated Gaussian data. For example, for each new frame, the system can update the display of the 3D persona based on the new data.

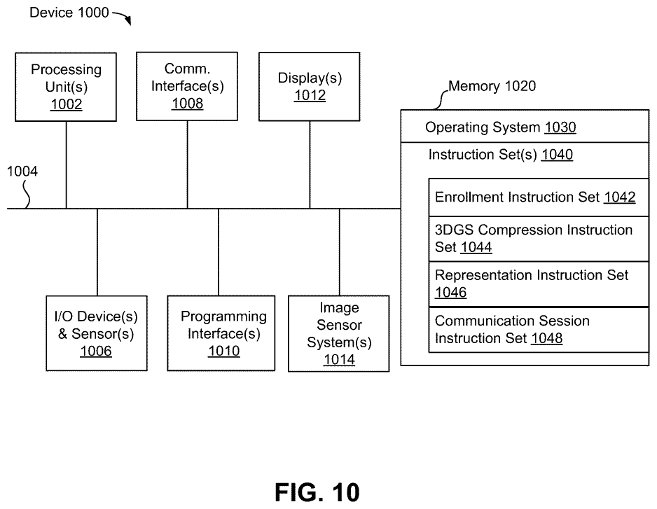

FIG. 10 is a block diagram of an example device 1000. Device 1000 illustrates an exemplary device configuration for devices described herein (e.g., devices 105, 710, 765, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 1010, one or more displays 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 1012 are configured to present a view of a physical environment or a graphical environment to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 1012 correspond to diffractive, reflective, polarized, holographic, etc. waveguide displays. In one example, the device 1000 includes a single display. In another example, the device 1000 includes a display for each eye of the user.

In some implementations, the one or more image sensor systems 1014 are configured to obtain image data that corresponds to at least a portion of the physical environment 102. For example, the one or more image sensor systems 1014 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 includes a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include an enrollment instruction set 1042, 3DGS compression instruction set 1044, a representation instruction set 1046, and a communication session instruction set 1048. The instruction set(s) 1040 may be embodied a single software executable or multiple software executables.

In some implementations, the enrollment instruction set 1042 is executable by the processing unit(s) 1002 to generate enrollment data from image data. The enrollment instruction set 1042 may be configured to provide instructions to the user in order to acquire image information to generate the enrollment personification (e.g., enrollment process 810 of FIG. 8) and determine whether additional image information is needed to generate an accurate enrollment personification to be used by the persona display process. To these ends, in various implementations, the instruction includes instructions and/or logic therefor, and heuristics and metadata therefor.

In some implementations, the 3DGS compression instruction set 1044 is executable by the processing unit(s) 1002 to compress 3DGS data based on a compression scheme (e.g., KL transforms or other generic learned transforms). The 3DGS compression instruction set 1044 may generate compressed versions of the 3DGS data that includes a reduction of multiple 2D textures of the 3DGS data (e.g., reducing the number, size, or data used, and using compression techniques based on KL-transforms for location (L), Rotation (R), Scale(S), and Color SH (C) that may be scalable across different bitrate targets) using one or more of the techniques discussed herein or as otherwise may be appropriate. To these ends, in various implementations, the instruction includes instructions and/or logic therefor, and heuristics and metadata therefor.

In some implementations, the representation instruction set 1046 is executable by the processing unit(s) 1002 to generate a representation of an object such as a user representation (e.g., rendering via a Gaussian splatting technique) by using one or more of the techniques discussed herein or as otherwise may be appropriate. In some implementations, the representation instruction set 1046 is executable by the processing unit(s) 1002 to analyze and select a splat rendering approach (e.g., a rendering mode) for use in providing a view that includes a representation based on a determined context of the viewing experience as discussed herein or as otherwise may be appropriate. To these ends, in various implementations, the instruction includes instructions and/or logic therefor, and heuristics and metadata therefor.

In some implementations, the communication session instruction set 1048 is executable by the processing unit(s) 1002 to facilitate a communication session between two or more electronic devices (e.g., device 710 and device 765 as illustrated in FIG. 7) using one or more of the techniques discussed herein or as otherwise may be appropriate. To these ends, in various implementations, the instruction includes instructions and/or logic therefor, and heuristics and metadata therefor.

Although the instruction set(s) 1040 are shown as residing on a single device, it should be understood that in other implementations, any combination of the elements may be located in separate computing devices. Moreover, FIG. 10 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

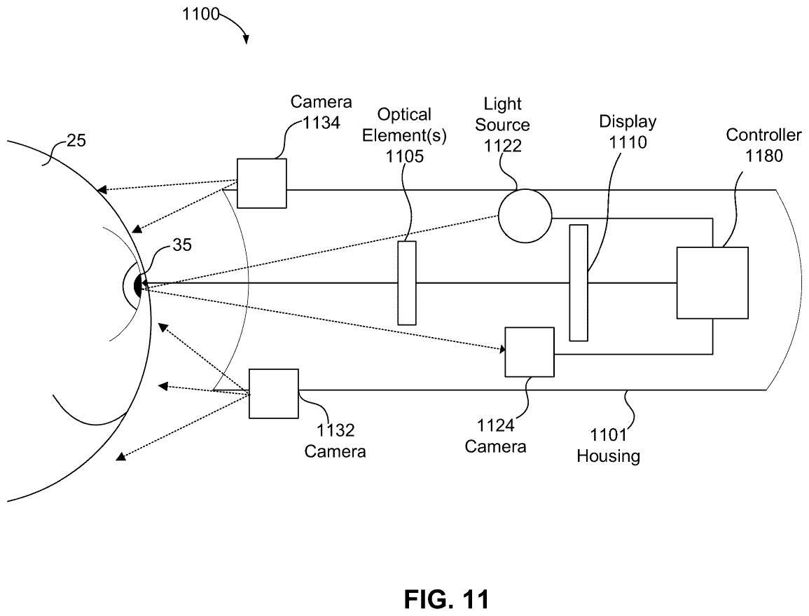

FIG. 11 illustrates a block diagram of an exemplary head-mounted device 1100 in accordance with some implementations. The head-mounted device 1100 includes a housing 1101 (or enclosure) that houses various components of the head-mounted device 1100. The housing 1101 includes (or is coupled to) an eye pad (not shown) disposed at a proximal (to the user 25) end of the housing 1101. In various implementations, the eye pad is a plastic or rubber piece that comfortably and snugly keeps the head-mounted device 1100 in the proper position on the face of the user 25 (e.g., surrounding the eye 35 of the user 25).

The housing 1101 houses a display 1110 that displays an image, emitting light towards or onto the eye of a user 25. In various implementations, the display 1110 emits the light through an eyepiece having one or more optical elements 1105 that refracts the light emitted by the display 1110, making the display appear to the user 25 to be at a virtual distance farther than the actual distance from the eye to the display 1110. For example, optical element(s) 1105 may include one or more lenses, a waveguide, other diffraction optical elements (DOE), and the like. For the user 25 to be able to focus on the display 1110, in various implementations, the virtual distance is at least greater than a minimum focal distance of the eye (e.g., 7 cm). Further, in order to provide a better user experience, in various implementations, the virtual distance is greater than 1 meter.

The housing 1101 also houses a tracking system including one or more light sources 1122, camera 1124, camera 1132, camera 1134, and a controller 1180. The one or more light sources 1122 emit light onto the eye of the user 25 that reflects as a light pattern (e.g., a circle of glints) that can be detected by the camera 1124. Based on the light pattern, the controller 1180 can determine an eye tracking characteristic of the user 25. For example, the controller 1180 can determine a gaze direction and/or a blinking state (eyes open or eyes closed) of the user 25. As another example, the controller 1180 can determine a pupil center, a pupil size, or a point of regard. Thus, in various implementations, the light is emitted by the one or more light sources 1122, reflects off the eye of the user 25, and is detected by the camera 1124. In various implementations, the light from the eye of the user 25 is reflected off a hot mirror or passed through an eyepiece before reaching the camera 1124.

The display 1110 emits light in a first wavelength range and the one or more light sources 1122 emit light in a second wavelength range. Similarly, the camera 1124 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 1110 by looking at it), provide foveated rendering (e.g., present a higher resolution in an area of the display 1110 the user 25 is looking at and a lower resolution elsewhere on the display 1110), or correct distortions (e.g., for images to be provided on the display 1110). In various implementations, the one or more light sources 1122 emit light towards the eye 35 of the user 25 which reflects in the form of a plurality of glints.

In various implementations, the camera 1124 is a frame/shutter-based camera that, at a particular point in time or multiple points in time at a frame rate, generates an image of the eye 35 of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1124 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1132 and camera 1134 are frame/shutter-based cameras that, at a particular point in time or multiple points in time at a frame rate, can generate an image of the face of the user 25. For example, camera 1132 captures images of the user's face below the eyes, and camera 1134 captures images of the user's face above the eyes. The images captured by camera 1132 and camera 1134 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a device:
obtaining three-dimensional Gaussian Splat (3DGS) data representing at least a portion of an element, wherein the 3DGS data comprises multiple two-dimensional (2D) textures that each represent values for a respective parameter at different 2D positions within the respective 2D texture such that pixel values of each 2D texture correspond to values of the respective parameter for corresponding portions of the element that is represented;
generating a compressed version of the 3DGS data that represents the at least the portion of the element based on a compression scheme, wherein the compressed version of the 3DGS data comprises a reduction of the multiple 2D textures of the 3DGS data; and
providing the compressed version of the 3DGS data, wherein a three-dimensional (3D) view of a representation of the at least the portion of the element is presented based on the compressed version of the 3DGS data.

2. The method of claim 1, wherein each of the 3D splats are associated with a particular splat parameter type of a plurality of splat parameter types.

3. The method of claim 2, wherein generating the compressed version of the 3DGS data based on the compression scheme comprises selecting one or more the plurality of splat parameter types, and applying the compression scheme using the selected one or more the plurality of splat parameter types.

4. The method of claim 2, wherein the plurality of splat parameter types comprises at least one of a location, a rotation, a scale, a color, and an opacity.

5. The method of claim 1, wherein the compression scheme is determined based on a network bandwidth condition.

6. The method of claim 1, wherein the compression scheme is determined based on a context associated with providing the compressed version of the 3DGS data.

7. The method of claim 1, wherein the compressed version of the 3DGS data comprises a reduction in at least of a number, a size, and an amount of data associated with the multiple 2D textures of the 3DGS data.

8. The method of claim 1, wherein the compression scheme comprises a machine learned method, a neural network, or a compression mapping algorithm.

9. The method of claim 1, wherein the compression scheme comprises a dimensionality-reduction transform.

10. The method of claim 9, wherein the dimensionality-reduction transform comprises a Karhunén-Loeve (KL) transform.

11. The method of claim 1, further comprising:
providing the compressed version of the 3DGS data to a different device to generate the view of the representation of the at least the portion of the element, wherein the different device decompresses the compressed version of the 3DGS data based on the compression scheme.

12. The method of claim 1, generating the compressed version of the 3DGS data that represents the at least the portion of the element is based on identifying particular regions of the element, wherein the compressed version of the 3DGS data comprises the reduction of the multiple 2D textures of the 3DGS data associated with the identified particular regions of the element at a rate that is different than other regions of the element.

13. The method of claim 1, wherein the 3D view of the representation of the at least the portion of the element is presented for multiple frames corresponding to successive instants in time and is used to provide a time-varying view of the element.

14. The method of claim 1, wherein the at least the portion of the element comprises a face portion and an additional portion of a user.

15. The method of claim 1, wherein the 3D view of the representation of the at least the portion of the element is presented based on 3D point cloud points associated with distribution data defining sizes and shapes for rendering the 3D point cloud points as splats.

16. The method of claim 1, wherein the device is a sender's device, wherein the compression scheme is selected based on data obtained during a communication session with a viewer's device associated with the view of the representation of the at least the portion of the element.

17. The method of claim 1, wherein the 3DGS data representing the at least the portion of the element is generated and updated during an enrollment process based on images of a face of a user captured while the user is expressing a plurality of different facial expressions.

18. The method of claim 1, wherein the 3DGS data representing the at least the portion of the element is generated via a machine learning model trained using training data obtained via one or more sensors in one or more environments.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining three-dimensional Gaussian Splat (3DGS) data representing at least a portion of an element, wherein the 3DGS data comprises multiple two-dimensional (2D) textures that each represent values for a respective parameter at different 2D positions within the respective 2D texture such that pixel values of each 2D texture correspond to values of the respective parameter for corresponding portions of the element that is represented;
generating a compressed version of the 3DGS data that represents the at least the portion of the element based on a compression scheme, wherein the compressed version of the 3DGS data comprises a reduction of the multiple 2D textures of the 3DGS data; and
providing the compressed version of the 3DGS data, wherein a three-dimensional (3D) view of a representation of the at least the portion of the element is presented based on the compressed version of the 3DGS data.

20. A non-transitory computer-readable storage medium, storing program instructions executable on a device to perform operations comprising:
obtaining three-dimensional Gaussian Splat (3DGS) data representing at least a portion of an element, wherein the 3DGS data comprises multiple two-dimensional (2D) textures that each represent values for a respective parameter at different 2D positions within the respective 2D texture such that pixel values of each 2D texture correspond to values of the respective parameter for corresponding portions of the element that is represented;
generating a compressed version of the 3DGS data that represents the at least the portion of the element based on a compression scheme, wherein the compressed version of the 3DGS data comprises a reduction of the multiple 2D textures of the 3DGS data; and
providing the compressed version of the 3DGS data, wherein a three-dimensional (3D) view of a representation of the at least the portion of the element is presented based on the compressed version of the 3DGS data.
